(19) United States
(12) Patent Application Publication
(10) Pub. No.: US 2026/0121731 A1
(43) Pub. Date: Apr. 30, 2026

(54) BEAM DETERMINATION METHOD AND APPARATUS, AND DEVICE AND STORAGE MEDIUM

(71) Applicant: Beijing Xiaomi Mobile Software Co., Ltd., Beijing (CN)

(72) Inventor: Mingju LI, Beijing (CN)

(21) Appl. No.: 19/118,857

(22) PCT Filed: Oct. 10, 2022
(86) PCT No.: PCT/CN2022/124469

§ 371 Date: Apr. 7, 2025

(51) Int. Cl. H04B 7/06

(52) U.S. Cl. CPC H04B 7/0696

(57) ABSTRACT

A method for determining a beam is performed by a first device, and includes: determining a number of reception beams supported by a beam prediction model; and determining an optimal beam from an output of the beam prediction model based on the number of reception beams supported by the beam prediction model.

### CROSS REFERENCE

The present application is a U.S. National Stage of International Application No. PCT/CN2022/124469, filed on Oct. 10, 2022, the content of which is incorporated herein by reference in its entirety.

### TECHNICAL FIELD

The present disclosure relates to the field of communication technologies, and in particular to a method and apparatus and device for determining a beam, and a storage medium.

### BACKGROUND

In New Radio (NR), especially when a communication frequency band is in frequency range 2, due to the rapid attenuation of high-frequency channels, beam-based transmission and reception are required to ensure coverage.

In a conventional beam management procedure, a base station will configure a reference signal resource set for beam measurement, and a terminal measures reference signal resources in the reference signal resource set and then reports one or more stronger reference signal resource identifiers and beam quality of the corresponding reference signals. In the related arts, the terminal needs to measure the reference signal for each beam pair, where a reception beam and a transmission beam constitute a beam pair.

In some technologies, the beam quality of all beam pairs can be obtained by means of Artificial Intelligence (AI) model prediction. However, the AI model is related to the number of reception beams. For the AI model, an output of the model is unchanged, but different terminals may support different numbers of reception beams, and the total number of beam pairs will also change.

### SUMMARY

According to a first aspect of embodiments of the present disclosure, there is provided a method for determining a beam, which is applied to a first device and includes: determining the number of reception beams supported by a beam prediction model; and determining an optimal beam from an output of the beam prediction model based on the number of reception beams supported by the beam prediction model.

According to a second aspect of embodiments of the present disclosure, there is provided a device for determining a beam, including: a processor; and a memory configured to store executable instructions of the processor; wherein the processor is configured to perform the method in the first aspect.

According to a third aspect of embodiments of the present disclosure, there is provided a non-transitory computer-readable storage medium storing instructions that, when executed by a processor of a first device, cause the first device to perform the method in the first aspect.

It should be noted that the above general description and the following detailed description are merely exemplary and explanatory and should not be construed as limiting of the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain principles of the present disclosure.

FIG. 1 shows a schematic diagram of a wireless communication system according to an embodiment of the present disclosure.

FIG. 2 shows a flowchart of a method for determining a beam according to an embodiment of the present disclosure.

FIG. 3 shows a flowchart of another method for determining a beam according to an embodiment of the present disclosure.

FIG. 4 shows a flowchart of yet another method for determining a beam according to an embodiment of the present disclosure.

FIG. 5 shows a flowchart of still another method for determining a beam according to an embodiment of the present disclosure.

FIG. 6 shows a flowchart of another method for determining a beam according to an embodiment of the present disclosure.

FIG. 7 shows a flowchart of yet another method for determining a beam according to an embodiment of the present disclosure.

FIG. 8 shows a flowchart of still another method for determining a beam according to an embodiment of the present disclosure.

FIG. 9 shows a flowchart of another method for determining a beam according to an embodiment of the present disclosure.

FIG. 10 shows a flowchart of yet another method for determining a beam according to an embodiment of the present disclosure.

FIG. 11 shows a flowchart of still another method for determining a beam according to an embodiment of the present disclosure.

FIG. 12 shows a flowchart of another method for determining a beam according to an embodiment of the present disclosure.

FIG. 13 shows a flowchart of yet another method for determining a beam according to an embodiment of the present disclosure.

FIG. 14 shows a flowchart of still another method for determining a beam according to an embodiment of the present disclosure.

FIG. 15 shows a flowchart of another method for determining a beam according to an embodiment of the present disclosure.

FIG. 16 shows a flowchart of yet another method for determining a beam according to an embodiment of the present disclosure.

FIG. 17 shows a flowchart of still another method for determining a beam according to an embodiment of the present disclosure.

FIG. 18 shows a flowchart of another method for determining a beam according to an embodiment of the present disclosure.

FIG. 19 shows a flowchart of yet another method for determining a beam according to an embodiment of the present disclosure.

FIG. 20 shows a flowchart of still another method for determining a beam according to an embodiment of the present disclosure.

FIG. 21 shows a flowchart of another method for determining a beam according to an embodiment of the present disclosure.

FIG. 22 shows a schematic diagram of an apparatus for determining a beam according to an embodiment of the present disclosure.

FIG. 23 shows a schematic diagram of another apparatus for determining a beam according to an embodiment of the present disclosure.

FIG. 24 shows a schematic diagram of a device for determining a beam according to an embodiment of the present disclosure.

FIG. 25 shows a schematic diagram of another device for determining a beam according to an embodiment of the present disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. Implementations set forth in the following description of the embodiments do not represent all implementations consistent with embodiments of the present disclosure.

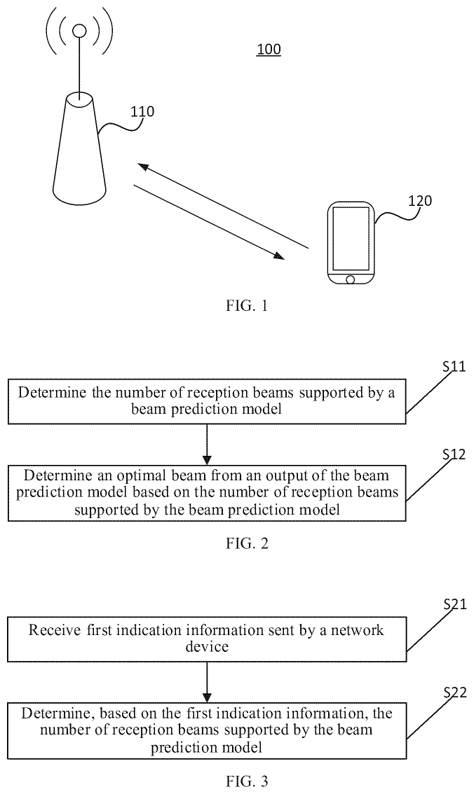

A communication method involved in the present disclosure can be applied to a wireless communication system 100 shown in FIG. 1. The network system may include a network device 110 and a terminal 120. It can be understood that the wireless communication system shown in FIG. 1 is only illustrative and may also include other network devices, for example, core network devices, radio relay devices, radio backhaul devices, etc., which are not depicted in FIG. 1. Embodiments of the present disclosure do not limit the number of network devices and the number of terminals included in the wireless communication system.

It can be further understood that the wireless communication system according to embodiments of the present disclosure is a network providing a wireless communication function. The wireless communication system may use different communication technologies, for example, Code Division Multiple Access (CDMA), Wideband Code Division Multiple Access (WCDMA), Time Division Multiple Access (TDMA), Frequency Division Multiple Access (FDMA), Orthogonal Frequency-Division Multiple Access (OFDMA), Single Carrier FDMA (SC-FDMA), and Carrier Sense Multiple Access with Collision Avoidance. Networks may be classified into 2nd generation (2G) networks, 3G networks, 4G networks, or future evolved networks, for example, 5th Generation Wireless Communication System (5G) networks according to factors of capacity, rate, latency, etc. of different networks. The 5G networks may also be referred to as new radio (NR) networks. For convenience of description, the present disclosure sometimes refers to a wireless communication network simply as a network.

Further, the network device 110 involved in the present disclosure may also be referred to as a radio access network device. The radio access network device may be a base station, an evolved Node B (eNB), a home base station, a radio relay node, a radio backhaul node, a transmission point (TP) or an access point (AP) in a Wireless Fidelity (WIFI) system, etc., or may be a gNB in an NR system, or may be a component or some of devices constituting a base station, etc. When the wireless communication system is a vehicle-to-everything (V2X) communication system, the network device may also be a vehicle-mounted device. It is to be understood that embodiments of the present disclosure do not limit a particular technology and a particular device configuration used by the network device.

Further, the terminal 120 involved in the present disclosure may also be referred to as a terminal device, a user equipment (UE), a mobile station (MS), a mobile terminal (MT), etc., and is a device that provides a user with speech and/or data connectivity. For example, the terminal may be a handheld device, a vehicle-mounted device, etc. which has a radio connection function. Some instances of the terminal include a mobile phone, a pocket personal computer (PPC), a palmtop computer, a personal digital assistant (PDA), a laptop computer, a tablet computer, a wearable device, a vehicle-mounted device, etc. Moreover, when the wireless communication system is the vehicle-to-everything (V2X) communication system, the terminal device may also be a vehicle-mounted device. It is to be understood that embodiments of the present disclosure do not limit a particular technology and a particular device configuration used by the terminal.

In embodiments of the present disclosure, the network device 110 and the terminal 120 may use any feasible wireless communication technology to achieve mutual data transmission. A transmission channel corresponding to the network device 110 sending data to the terminal 120 is called a downlink channel (DL), and a transmission channel corresponding to the terminal 120 sending data to the network device 110 is called an uplink channel (UL). It can be understood that the network device involved in embodiments of the present disclosure may be a base station. Alternatively, the network device may also be any other possible network device, and the terminal may be any possible terminal, which is not limited by the present disclosure.

In the NR, especially when a communication frequency band is in frequency range 2, due to the rapid attenuation of high-frequency channels, beam-based transmission and reception are required to ensure coverage.

In a conventional beam management procedure, a base station will configure a reference signal resource set for beam measurement, and a terminal measures reference signal resources in the reference signal resource set and then reports one or more stronger reference signal resource identifiers and the corresponding layer-1 reference signal received powers (L1-RSRPs) and/or layer-1 signal to interference plus noise ratios (L1-SINRs). The terminal needs to measure the reference signal for each beam pair, where a reception beam and a transmission beam constitute a beam pair. For example, the reference signal resource set configured by the network device includes X reference signals, and each reference signal corresponds to a different transmission beam of the network device. For each reference signal, the terminal needs to measure all reception beams for the reference signal to obtain beam quality corresponding to all reception beams, respectively, and determine the best beam quality. Therefore, the number of beam pairs that the terminal needs to measure is A*B, where A is the number of transmission beams of the network device, and B is the number of reception beams of the terminal.

In the related arts, in order to reduce the number of beam pairs measured by the terminal, an AI model-based prediction method is adopted. For example, the number of beam pairs that the terminal originally needs to measure is A*B. Due to the AI model, the terminal only needs to measure part of the A*B beam pairs, such as ⅛ or ¼ of A*B beam pairs, and so on. The beam quality of the measured beam pair is then input into the AI model, and the AI model can output at least one of the beam quality of the A*B beam pairs, the strongest beam pair among the A*B beam pairs, the strongest a transmission beams, and the strongest b reception beams. It can be understood that a is less than or equal to A, and b is less than or equal to B.

Obviously, the AI model is related to the number of reception beams. Then whether to train different AI models or to train the same AI model for different numbers of reception beams, and how to instruct the terminal are problems that need to be solved.

If only one AI model is trained, the total number of beam pairs will be different for terminals with different numbers of reception beams. Since the output of the AI model is unchanged, how to obtain results required by different terminals from the output of the AI model is a problem that needs to be solved.

Therefore, the present disclosure provides a method for determining a beam. An optimal beam can be determined from an output of a beam prediction model through the number of reception beams supported by the beam prediction model, so that terminals supporting different numbers of reception beams can use the same beam prediction model to determine the optimal beam suitable for each terminal.

It should be noted that in the following embodiments of the present disclosure, a first device is a terminal and a second device is a network device; or, when the first device is the network device, the second device is the terminal.

FIG. 2 shows a flowchart of a method for determining a beam according to an embodiment of the present disclosure. As shown in FIG. 2, the method is applied to a terminal and may include steps S11 and S12.

In the step S11, the number of reception beams supported by a beam prediction model is determined.

In some embodiments, the terminal may determine the number of reception beams supported by the beam prediction model.

For example, if the beam prediction model is trained on the terminal, the terminal can directly determine the number of reception beams supported by the beam prediction model. For another example, if the beam prediction model is trained on another device other than the terminal, the terminal can determine, through indication information of the other device, the number of reception beams supported by the beam prediction model.

In the step S12, an optimal beam is determined from an output of the beam prediction model based on the number of reception beams supported by the beam prediction model.

In some embodiments, the terminal may determine the optimal beam from the output of the beam prediction model based on the number of reception beams supported by the beam prediction model determined in the S11.

In some embodiments, the optimal beam may be a beam with the best beam quality when the terminal communicates. The optimal beam may include at least one of an optimal transmission beam, an optimal reception beam, and an optimal beam pair. The optimal beam pair includes a transmission beam and a reception beam.

In some embodiments, the optimal beam may include one optimal beam or a plurality of optimal beams.

In the present disclosure, the optimal beam can be determined from the output of the beam prediction model through the number of reception beams supported by the beam prediction model, so that terminals supporting different numbers of reception beams can use the same beam prediction model to determine the optimal beam suitable for each terminal.

In the method for determining the beam provided in embodiments of the present disclosure, FIG. 3 shows a flowchart of another method for determining a beam according to an embodiment of the present disclosure. As shown in FIG. 3, determining the number of reception beams supported by the beam prediction model in the S11 may include steps S21 and S22.

In the step S21, first indication information sent by a network device is received.

In some embodiments, the terminal may receive the first indication information sent by the network device, and the first indication information is used to indicate the number of reception beams supported by the beam prediction model.

For example, the network device may be a device that pre-trains the beam prediction model.

In the step S22, the number of reception beams supported by the beam prediction model is determined based on the first indication information.

In some embodiments, the terminal may determine, based on the first indication information received in the S21, the number of reception beams supported by the beam prediction model.

In the present disclosure, the number of reception beams supported by the beam prediction model can also be determined through the indication information from another device, so as to determine the optimal beam from the output of the beam prediction model based on the number of reception beams supported by the beam prediction model, so that terminals supporting different numbers of reception beams can use the same beam prediction model to determine the optimal beam suitable for each terminal.

In the method for determining the beam provided in embodiments of the present disclosure, the number of reception beams supported by the beam prediction model may include: a maximum number of reception beams supported by the beam prediction model; or one or more numbers of reception beams supported by the beam prediction model.

In some embodiments, the number of reception beams that the beam prediction model can support may be the maximum number of reception beams supported by the beam prediction model, for example, denoted as Rx_num.

In some embodiments, the number of reception beams that the beam prediction model can support can be one or more numbers of reception beams. For example, the beam prediction model can support one or more different numbers of reception beams, and the one or more numbers of reception beams can correspond to one number of reception beams or a plurality of different numbers of reception beams that the beam prediction model can support.

In the present disclosure, the optimal beam is determined from the output of the beam prediction model through the number of reception beams that the beam prediction model can support, so that terminals supporting different numbers of reception beams can use the same beam prediction model to determine the optimal beam suitable for each terminal.

In the method for determining the beam provided in embodiments of the present disclosure, in response to the beam prediction model supporting the plurality of numbers of reception beams, the plurality of numbers of reception beams may include a first number and a second number. The first number is the maximum number of reception beams supported by the beam prediction model, the first number is N times the second number, the minimum value of the second number is 1, and N is a positive integer.

In some embodiments, the beam prediction model may support the plurality of numbers of reception beams. The plurality of numbers of reception beams may include the first number representing the maximum number of reception beams supported by the beam prediction model. It should be understood that the first number may be Rx_num. The plurality of numbers of reception beams may include the second number, the first number is N times the second number, the minimum value of the second number is 1, and N is the positive integer.

For example, the second number may

$$\frac{Rx\_num}{N} ,$$

such as

$$\frac{Rx\_num}{2} , \frac{Rx\_num}{4} , \frac{Rx\_num}{8}$$

and so on. The plurality of numbers of reception beams may include one or more second numbers. For example, the plurality of numbers of reception beams may include Rx_num and

$$\frac{Rx\_num}{2} .$$

For another example, the plurality of numbers of reception beams may include Rx_num,

$$\frac{Rx\_num}{2} , \frac{Rx\_num}{4} and \frac{Rx\_num}{8} .$$

For yest another example, the plurality of numbers of reception beams may include Rx_num,

$$\frac{Rx\_num}{2} , \frac{Rx\_num}{4} , \frac{Rx\_num}{8} , … and 1.$$

It can be understood that the above is only an illustrative description, and the present disclosure does not limit how many second numbers are included in the plurality of numbers of reception beams, nor does it limit the specific multiple relationship between the second number and the first number.

In some embodiments, the first number may be 2ⁿ times the second number, where n is a non-negative integer. For example, the second number may be

$$\frac{Rx\_num}{2} , \frac{Rx\_num}{4} , \frac{Rx\_num}{8} , \frac{Rx\_num}{16}$$

and so on.

In the present disclosure, the beam prediction model can support the plurality of different numbers of reception beams, so that terminals supporting different numbers of reception beams can use the same beam prediction model to determine the optimal beam suitable for each terminal.

In the method for determining the beam provided in embodiments of the present disclosure, determining the optimal beam from the output of the beam prediction model includes: receiving second indication information sent by the network device, and determining the optimal beam from the output of the beam prediction model based on the second indication information; or, determining the optimal beam from the output of the beam prediction model according to a predefined rule.

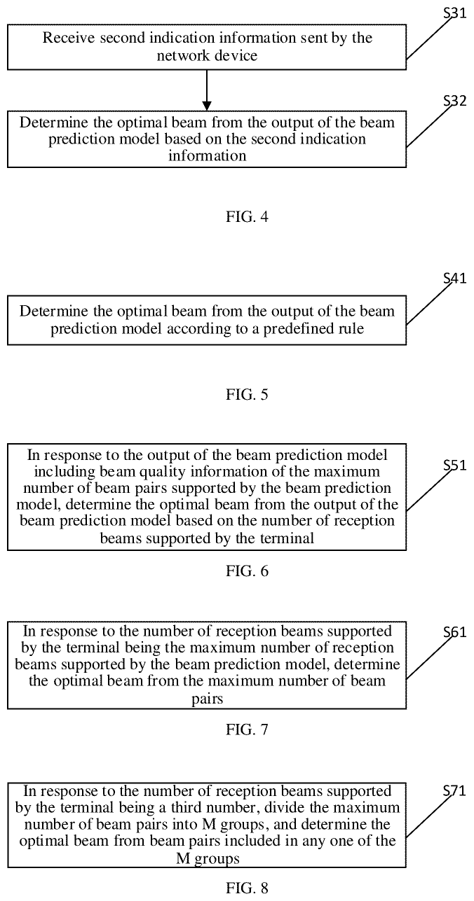

In some embodiments, FIG. 4 shows a flowchart of yet another method for determining a beam according to an embodiment of the present disclosure. As shown in FIG. 4, determining the optimal beam from the output of the beam prediction model in the S12 may include steps S31 and S32.

In the step S31, second indication information sent by the network device is received.

In some embodiments, the terminal may receive the second indication information sent by the network device, and the second indication information is used to indicate the optimal beam.

For example, the second indication information may be a beam identifier range where the optimal beam is located. The terminal may determine the optimal beam from beams within the beam identifier range where the optimal beam is located. Alternatively, the second indication information may be beam quality corresponding to the optimal beam. Alternatively, the second indication information may also be any equivalent information used to indicate the optimal beam, which is not limited in the present disclosure.

It can be understood that the network device can use the beam prediction model to predict the optimal beam, and the network device indicates the predicted optimal beam to the terminal through the second indication information.

In the step S32, the optimal beam is determined from the output of the beam prediction model based on the second indication information.

In some embodiments, the terminal may determine the optimal beam from the output of the beam prediction model based on the second indication information received in the S31.

In some embodiments, FIG. 5 shows a flowchart of still another method for determining a beam according to an embodiment of the present disclosure.

In step S41, the optimal beam is determined from the output of the beam prediction model according to a predefined rule.

In some embodiments, the terminal may determine the optimal beam from the output of the beam prediction model according to the predefined rule.

For example, the output of the beam prediction model is all beam identifiers. The terminal can determine, according to the predefined rule, the beam identifier range corresponding to the optimal beam, and then determine the optimal beam from the beams within the beam identifier range corresponding to the optimal beam.

It can be understood that one case may be that the optimal beam is predicted by using the beam prediction model on the network device, and the terminal may determine the beam identifier range corresponding to the optimal beam by using the predefined rule or the indication information of the network device, and determine the optimal beam from the beams within the beam identifier range corresponding to the optimal beam. The terminal may also determine the beam quality corresponding to the optimal beam by using the indication information of the network device, and determine the optimal beam. Alternatively, another case may be that the optimal beam is predicted by using the beam prediction model on the terminal, and the terminal may determine, by using the predefined rule, the optimal beam from beams output by the beam prediction model.

In the present disclosure, the optimal beam can be determined from the output of the beam prediction model through the indication information of the network device or the predefined rule, so that terminals supporting different numbers of reception beams can use the same beam prediction model to determine the optimal beam suitable for each terminal.

In the method for determining the beam provided in embodiments of the present disclosure, FIG. 6 shows a flowchart of another method for determining a beam according to an embodiment of the present disclosure. As shown in FIG. 6, determining the optimal beam from the output of the beam prediction model in the S32 or S41 may include a step S51.

In the step S51, in response to the output of the beam prediction model including beam quality information of a maximum number of beam pairs supported by the beam prediction model, the optimal beam is determined from the output of the beam prediction model based on the number of reception beams supported by the terminal.

In some embodiments, in response to the output of the beam prediction model including the beam quality information of the maximum number of beam pairs supported by the beam prediction model, such as reference signal received powers (RSRPs) and/or signal to interference plus noise ratios (SINRs) of the maximum number of beam pairs, where the maximum number may be the product of the number Tx_num of transmission beams of the network device and the maximum number Rx_num of reception beams supported by the beam prediction model, that is, Tx_num×Rx_num, the terminal may determine the optimal beam from the output of the beam prediction model based on the number of reception beams supported by the terminal. That is, the terminal may determine, based on the number of reception beams supported by the terminal, the optimal beam from the beam quality information of the maximum number of beam pairs.

In the present disclosure, when the output of the beam prediction model includes the beam quality information of the maximum number of beam pairs supported by the beam prediction model, the optimal beam can be determined from the output of the beam prediction model based on the number of reception beams supported by the terminal, so that terminals supporting different numbers of reception beams can use the same beam prediction model to determine the optimal beam suitable for each terminal.

In the method for determining the beam provided in embodiments of the present disclosure, FIG. 7 shows a flowchart of yet another method for determining a beam according to an embodiment of the present disclosure. As shown in FIG. 7, determining the optimal beam from the output of the beam prediction model based on the number of reception beams supported by the terminal in the S51 may include a step S61.

In the step S61, in response to the number of reception beams supported by the terminal being the maximum number of reception beams supported by the beam prediction model, the optimal beam is determined from the maximum number of beam pairs.

In some embodiments, if the number of reception beams supported by the terminal is the maximum number of reception beams supported by the beam prediction model, the terminal can determine the optimal beam from the maximum number of beam pairs.

For example, the terminal determines one or more beam pairs with the best beam quality from the maximum number of beam pairs. If the optimal beam is the optimal reception beam, the reception beam corresponding to the one or more beam pairs with the best beam quality can be used as the optimal reception beam. If the optimal beam is the optimal transmission beam, the transmission beam corresponding to the one or more beam pairs with the best beam quality can be used as the optimal transmission beam. If the optimal beam is the optimal beam pair, the one or more beam pairs with the best beam quality can be used as the optimal beam pair.

It can be understood that how to determine the one or more beam pairs with the best beam quality can be realized using the existing methods. For example, when the beam quality meets the corresponding conditions, the beam quality of the corresponding beam pair can be considered to be the best. The specific conditions can be set accordingly based on actual conditions, which are not limited by the present disclosure.

In the present disclosure, when the number of reception beams supported by the terminal is the maximum number of reception beams supported by the beam prediction model, the optimal beam can be determined from the maximum number of beam pairs output by the beam prediction model, so that the beam prediction model can adapt to the terminal whose number of reception beams is the maximum number of reception beams supported by the beam prediction model.

In the method for determining the beam provided in embodiments of the present disclosure, FIG. 8 shows a flowchart of still another method for determining a beam according to an embodiment of the present disclosure. As shown in FIG. 8, determining the optimal beam from the output of the beam prediction model based on the number of reception beams supported by the terminal in the S51 may include a step S71.

In the step S71, in response to the number of reception beams supported by the terminal being a third number, the maximum number of beam pairs are divided into M groups, and the optimal beam is determined from beam pairs included in any one of the M groups.

In some embodiments, if the number of reception beams supported by the terminal is the third number, the maximum number of beam pairs may be divided into the M groups. The terminal determines the optimal beam from the beam pairs included in any one of the M groups. The third number is 1/M of the maximum number of reception beams supported by the beam prediction model, and M is a positive integer.

For example, the third number is

$$\frac{Rx\_num}{M} .$$

When the number of reception beams supported by the terminal is

$$\frac{Rx\_num}{M} .$$

the maximum number of beam pairs can be divided into the M groups. Each group can include

$$\frac{Tx\_num \times Rx\_num}{M}$$

beam pairs. The terminal can determine the optimal beam pair from the beam pairs contained in any one of the M groups. For example, the terminal determines the optimal beam from the

$$\frac{Tx\_num \times Rx\_num}{M}$$

beam pairs contained in any one of the M groups.

In some embodiments, M is 2, then the third number is

$$\frac{Rx\_num}{2} .$$

The maximum number of beam pairs can be divided into 2 groups, and the terminal determines the optimal beam from the

$$\frac{Tx\_num \times Rx\_num}{2}$$

beam pairs contained in any one of the 2 groups. In other words, the terminal determines the optimal beam from any half of the maximum number of beam pairs.

In some embodiments, M is 4, then the third number is

$$\frac{Rx\_num}{4} .$$

The maximum number of beam pairs can be divided into 4 groups, and the terminal determines the optimal beam from the

$$\frac{Tx\_num \times Rx\_num}{4}$$

beam pairs contained in any one of the 4 groups. In other words, the terminal determines the optimal beam from one quarter of the maximum number of beam pairs.

In some embodiments, M is 2^{n′}, where n′ is a non-negative integer. For example, the third number is

$$\frac{Rx\_num}{2} , \frac{Rx\_num}{4} , \frac{Rx\_num}{8}$$

and so on.

In some embodiments, the minimum value of the third number may be 1, that is, M is equal to Rx_num. Accordingly, dividing the maximum number of beam pairs into the M groups may be dividing the maximum number of beam pairs into Rx_num groups.

It can be understood that the above is only an illustrative description, and the present disclosure does not limit the value of M. The specific value of M can be selected according to actual conditions.

In the present disclosure, when the number of reception beams supported by the terminal is within the maximum number of reception beams supported by the beam prediction model, the maximum number of beam pairs is grouped, and the optimal beam is determined from a plurality of beam pairs in any group, so that the beam prediction model can adapt to the terminal whose number of reception beams is within the maximum number of reception beams supported by the beam prediction model.

In the method for determining the beam provided in embodiments of the present disclosure, dividing the maximum number of beam pairs into the M groups in the S71 may include at least one of: dividing the maximum number of beam pairs into the M groups according to the beam pairs, and numbers of beam pairs in each group are continuous or discontinuous; dividing the maximum number of beam pairs into the M groups according to reception beams corresponding to the beam pairs, and beam pairs corresponding to the same reception beam belong to the same group; or dividing the maximum number of beam pairs into the M groups, beam pairs corresponding to the same reception beam are divided into M sub-groups, and the M sub-groups and the M groups are in one-to-one correspondence.

In some embodiments, dividing the maximum number of beam pairs into the M groups may be: dividing the maximum number of beam pairs into the M groups according to the beam pairs, and the numbers of the beam pairs in each group are continuous.

For example, the maximum number of beam pairs is divided into the M groups according to the beam pairs. For example, the maximum number of beam pairs is 32 beam pairs and the M groups are 4 groups. The 32 beam pairs can be divided into 4 groups according to the beam pairs, and each group can include 8 beam pairs. The numbers of the 8 beam pairs in each group are continuous. In some embodiments, the beam pair number can be a beam pair identifier, and the identifier is, for example, an identity (ID) or an index.

For example, M is 2, and the third number is

$$\frac{Rx\_num}{2} .$$

The maximum number of beam pairs can be divided into 2 groups according to the beam pairs, and the numbers of the beam pairs in each group are continuous. That is, each group corresponds to half of the maximum number of beam pairs. The 2 groups can correspond to the first half of the maximum number of beam pairs and the second half of the maximum number of beam pairs, respectively. It can be understood that the numbers of the first half of the maximum number of beam pairs are continuous, and the numbers of the second half of the maximum number of beam pairs are continuous.

For example, M is 4, and the third number is

$$\frac{Rx\_num}{4} .$$

The maximum number of beam pairs can be divided into 4 groups according to the beam pairs. The numbers of the beam pairs in each group are continuous. That is, each group corresponds to one quarter of the maximum number of beam pairs. It can be understood that the numbers of one quarter of the maximum number of beam pairs corresponding to any group are continuous.

In some embodiments, dividing the maximum number of beam pairs into the M groups may be: dividing the maximum number of beam pairs into the M groups according to the beam pairs, and the numbers of the beam pairs in each group are discontinuous.

For example, the maximum number of beam pairs is divided into the M groups according to the beam pairs. For example, the maximum number of beam pairs is 32 beam pairs and the M groups are 4 groups. The 32 beam pairs can be divided into 4 groups according to the beam pairs, and each group can include 8 beam pairs. The numbers of the 8 beam pairs in each group are discontinuous. In some embodiments, the beam pair number can be a beam pair identifier, and the identifier is, for example, an ID or an index.

For example, M is 2, and the third number is

$$\frac{Rx\_num}{2} .$$

The maximum number of beam pairs can be divided into 2 groups according to the beam pairs, and the numbers of the beam pairs in each group are discontinuous. That is, each group corresponds to half of the maximum number of beam pairs. The 2 groups can correspond to a half with beam pairs of odd numbers and a half with beam pairs of even numbers, respectively.

For example, M is 4, and the third number is

$$\frac{Rx\_num}{4} .$$

The maximum number of beam pairs can be divided into 4 groups according to the beam pairs, and the numbers of the beam pairs in each group are discontinuous. That is, each group corresponds to one quarter of the maximum number of beam pairs, and the numbers of the beam pairs in each group are discontinuous. Assuming that the maximum number of beam pairs is 16, numbers of beam pairs in group 1 can be 1, 5, 9, 13; numbers of beam pairs in group 2 can be 2, 6, 10, 14; numbers of beam pairs in group 3 can be 3, 7, 11, 15; and numbers of beam pairs in group 4 can be 4, 8, 12, 16.

In some embodiments, the maximum number of beam pairs are divided into the M groups according to the reception beams corresponding to the beam pairs, and the beam pairs corresponding to the same reception beam belong to the same group.

For example, the maximum number of beam pairs are divided into M groups according to the reception beams corresponding to the beam pairs, and the beam pairs corresponding to the same reception beam belong to the same group. For example, the maximum number of beam pairs is 32 beam pairs and the M groups are 4 groups. The 32 beam pairs can be divided into 4 groups according to the reception beams corresponding to the beam pairs. It can be understood that the beam pairs corresponding to the same reception beam belong to the same group. It can be understood that the beam pairs contained in each of the 4 groups can correspond to one or more reception beams. For example, the beam pairs contained in any one group correspond to the same reception beam, or any one group can contain beam pairs corresponding to a plurality of reception beams. However, it should be noted that the beam pairs corresponding to the same reception beam should belong to the same group. In addition, the value of M should be less than or equal to the maximum number of reception beams supported by the model.

For example, the numbers of the beam pairs in each of the M groups may be continuous or discontinuous. For example, if the beam pairs contained in any one group correspond to the same reception beam, the numbers of the beam pairs in the group may be continuous. For another example, if the beam pairs contained in any one group correspond to the plurality of reception beams, and the reception beam numbers of the plurality of reception beams are continuous, the numbers of the beam pairs in the group may be continuous. For example, if the beam pairs contained in any one group correspond to reception beams with reception beam numbers of 1 and 2, the numbers of the beam pairs in the group may be continuous. For another example, if the beam pairs contained in any one group correspond to the plurality of reception beams, and the reception beam numbers of the plurality of reception beams are discontinuous, the numbers of the beam pairs in the group may be discontinuous. For example, if the beam pairs included in any group correspond to the reception beams with reception beam numbers 1 and 5, the numbers of the beam pairs in the group may be discontinuous. That is, numbers of the beam pairs in the group are: a plurality of beam pairs with continuous numbers corresponding to the reception beam with the reception beam number of 1, and a plurality of beam pairs with continuous numbers corresponding to the reception beam with the reception beam number of 5.

It can be understood that if the reception beam is the reception beam of the terminal and the transmission beam is the transmission beam of the network device, the number of beam pairs corresponding to each reception beam should be the same as the number Tx_num of transmission beams of the network device.

For example, M is 2, the third number is

$$\frac{Rx\_num}{2} ,$$

and the maximum number of reception beams supported by the model is 8. The maximum number of beam pairs can be divided into 2 groups according to the reception beams corresponding to the beam pairs. The beam pairs corresponding to the same reception beam belong to the same group. That is to say, each group corresponds to half of the maximum number of beam pairs, and each group includes beam pairs corresponding to 4 reception beams. The 4 reception beams corresponding to each group can be 4 continuous reception beams, or 4 discontinuous reception beams. For example, the 4 reception beams corresponding to the 2 groups can be reception beam 1, reception beam 2, reception beam 3 and reception beam 4, as well as reception beam 5, reception beam 6, reception beam 7 and reception beam 8, respectively. In this case, the numbers of the beam pairs in the 2 groups can be continuous. For another example, the 4 reception beams corresponding to the 2 groups can be reception beam 1, reception beam 3, reception beam 5 and reception beam 7, as well as reception beam 2, reception beam 4, reception beam 6 and reception beam 8, respectively. In this case, the numbers of the beam pairs in the 2 groups may be discontinuous. That is, numbers of the beam pairs in one of the 2 groups are: a plurality of beam pairs with continuous numbers corresponding to reception beam 1, a plurality of beam pairs with continuous numbers corresponding to reception beam 3, a plurality of beam pairs with continuous numbers corresponding to reception beam 5, and a plurality of beam pairs with continuous numbers corresponding to reception beam 7; and numbers of the beam pairs in the other group are: a plurality of beam pairs with continuous numbers corresponding to reception beam 2, a plurality of beam pairs with continuous numbers corresponding to reception beam 4, a plurality of beam pairs with continuous numbers corresponding to reception beam 6, and a plurality of beam pairs with continuous numbers corresponding to reception beam 8.

For example, M is 4, the third number is

$$\frac{Rx\_num}{4} ,$$

and the maximum number of reception beams supported by the model is 8. The maximum number of beam pairs can be divided into 4 groups according to the reception beams corresponding to the beam pairs. The beam pairs corresponding to the same reception beam belong to the same group. That is to say, each group corresponds to one quarter of the maximum number of beam pairs, and each group contains beam pairs corresponding to 2 reception beams. The corresponding 2 reception beams in each group can be 2 continuous reception beams, or 2 discontinuous reception beams. For example, the corresponding 2 reception beams in the 4 groups can be reception beam 1 and reception beam 2, reception beam 3 and reception beam 4, reception beam 5 and reception beam 6, and reception beam 7 and reception beam 8, respectively. In this case, the numbers of the beam pairs in the 4 groups can be continuous. For another example, the corresponding 2 reception beams in the 4 groups can be reception beam 1 and reception beam 5, reception beam 2 and reception beam 6, reception beam 3 and reception beam 7, and reception beam 4 and reception beam 8, respectively; or reception beam 1 and reception beam 3, reception beam 5 and reception beam 7, reception beam 2 and reception beam 4, reception beam 6 and reception beam 8, respectively; or other discontinuous cases. In this case, the numbers of the beam pairs in the 4 groups may be discontinuous. That is, numbers of the beam pairs in any group are a plurality of beam pairs with continuous numbers corresponding to a plurality of discontinuous reception beams.

In some embodiments, the maximum number of beam pairs are divided into the M groups, the beam pairs corresponding to the same reception beam are divided into M sub-groups, and the M sub-groups and the M groups are in the one-to-one correspondence.

For example, the maximum number of beam pairs is divided into the M groups. The beam pairs corresponding to the same reception beam are divided into the M sub-groups, and the M sub-groups and the M groups are in the one-to-one correspondence. Based on the M sub-groups corresponding to each reception beam, the M groups are formed. For example, the maximum number of beam pairs is 32 beam pairs, the M groups are 4 groups, and the maximum number of reception beams supported by the model is 8. The 32 beam pairs can be divided into 4 groups. The beam pairs corresponding to each reception beam can be divided into 4 sub-groups. The 4 groups can be composed of 8 sub-groups corresponding to respective reception beams. For example, the beam pairs of reception beam 1 is divided into sub-group 11, sub-group 12, sub-group 13, and sub-group 14; the beam pairs of reception beam 2 is divided into sub-group 21, sub-group 22, sub-group 23, and sub-group 24; . . . ; and the beam pairs of reception beam 8 is divided into sub-group 81, sub-group 82, sub-group 83, and sub-group 84. Group 1 can be composed of sub-group 11, sub-group 21, . . . , and sub-group 81; group 2 can be composed of sub-group 12, sub-group 22, . . . , and sub-group 82; group 3 can be composed of sub-group 13, sub-group 23, . . . , and sub-group 83; and group 4 can be composed of sub-group 14, sub-group 24, . . . , and sub-group 84.

It can be understood that the numbers of the plurality of beam pairs corresponding to each sub-group can be continuous or discontinuous.

For example, M is 2, the third number is

$$\frac{Rx\_num}{2} ,$$

and the maximum number of reception beams supported by the model is 8. The maximum number of beam pairs can be divided into 2 groups according to the reception beams corresponding to the beam pairs. The beam pairs corresponding to the same reception beam are divided into 2 sub-groups. That is to say, each group corresponds to half of the maximum number of beam pairs, and the beam pairs corresponding to each reception beam are divided into 2 sub-groups. Based on the 2 sub-groups corresponding to each reception beam, 2 groups are formed. The numbers of the plurality of beam pairs corresponding to each sub-group can be continuous. For example, among beam pairs corresponding to a reception beam, a plurality of beam pairs with numbers in the first half constitute a sub-group corresponding to the reception beam, and a plurality of beam pairs with numbers in the second half constitute the other sub-group corresponding to the reception beam. Assuming that a reception beam corresponds to 8 beam pairs, a plurality of beam pairs with numbers of 1, 2, 3, and 4 constitute a sub-group, and a plurality of beam pairs with numbers of 5, 6, 7, and 8 constitute the other sub-group. The numbers of the plurality of beam pairs corresponding to each sub-group may be discontinuous. For example, among beam pairs corresponding to a reception beam, a plurality of beam pairs with odd numbers constitute a sub-group corresponding to the reception beam, and a plurality of beam pairs with even numbers constitute the other sub-group corresponding to the reception beam. Assuming that a reception beam corresponds to 8 beam pairs, a plurality of beam pairs with numbers of 1, 3, 5, and 7 constitute a sub-group, and a plurality of beam pairs with numbers of 2, 4, 6, and 8 constitute the other sub-group. Based on 2 sub-groups corresponding to each of the 8 reception beams, 2 groups are formed. Group 1 can be composed of sub-groups 1 corresponding to respective reception beams of the 8 reception beams, and group 2 can be composed of sub-groups 2 corresponding to respective reception beams of the 8 reception beams.

For example, M is 4, the third number is

$$\frac{Rx\_num}{4} ,$$

and the maximum number of reception beams supported by the model is 8. The maximum number of beam pairs can be divided into 4 groups according to the reception beams corresponding to the beam pairs. The beam pairs corresponding to the same reception beam are divided into 4 sub-groups. That is to say, each group corresponds to one quarter of the maximum number of beam pairs, and the beam pairs corresponding to each reception beam are divided into 4 sub-groups. Based on the 4 sub-groups corresponding to each reception beam, 4 groups are formed. The numbers of the plurality of beam pairs corresponding to each sub-group may be continuous. For example, among beam pairs corresponding to a reception beam, a plurality of beam pairs with one quarter of continuous numbers constitute a sub-group corresponding to the reception beam. Assuming that a reception beam corresponds to 8 beam pairs, a plurality of beam pairs with numbers of 1 and 2 constitute sub-group 1, a plurality of beam pairs with numbers of 3 and 4 constitute sub-group 2, a plurality of beam pairs with numbers of 5 and 6 constitute sub-group 3, and a plurality of beam pairs with numbers of 7 and 8 constitute sub-group 4. The numbers of the plurality of beam pairs corresponding to each sub-group may be discontinuous. Assuming that a reception beam corresponds to 8 beam pairs, a plurality of beam pairs with numbers of 1 and 5 constitute sub-group 1, a plurality of beam pairs with numbers of 2 and 6 constitute sub-group 2, a plurality of beam pairs with numbers of 3 and 7 constitute sub-group 3, and a plurality of beam pairs with numbers of 4 and 8 constitute sub-group 4. Alternatively, a plurality of beam pairs with numbers of 1 and 3 constitute sub-group 1, a plurality of beam pairs with numbers of 2 and 4 constitute sub-group 2, a plurality of beam pairs with numbers of 5 and 7 constitute sub-group 3, a plurality of beam pairs with numbers of 6 and 8 constitute sub-group 4, and other discontinuous cases may be possible. 4 groups can be formed based on 4 sub-groups corresponding to each of the 8 reception beams. Group 1 may be composed of sub-groups 1 corresponding to respective reception beams of the 8 reception beams, group 2 may be composed of sub-groups 2 corresponding to respective reception beams of the 8 reception beams, group 3 may be composed of sub-groups 3 corresponding to respective reception beams of the 8 reception beams, and group 4 may be composed of sub-groups 4 corresponding to respective reception beams of the 8 reception beams.

The present disclosure provides a variety of different ways to group the maximum number of beam pairs, so that when the number of reception beams supported by the terminal is within the maximum number of reception beams supported by the beam prediction model, the optimal beam can be determined from the plurality of beam pairs in any group, and then the beam prediction model can adapt to the terminal whose number of reception beams is within the maximum number of reception beams supported by the beam prediction model.

In the method for determining the beam provided in embodiments of the present disclosure, FIG. 9 shows a flowchart of another method for determining a beam according to an embodiment of the present disclosure. As shown in FIG. 9, determining the optimal beam from the output of the beam prediction model in the S32 or S41 may include a step S81.

In the step S81, in response to the output of the beam prediction model including candidate optimal beams, the optimal beam is determined according to the candidate optimal beams.

In some embodiments, the beam prediction model may directly output the candidate optimal beams, and the terminal may determine the optimal beam from the candidate optimal beams output by the beam prediction model.

In some embodiments, the output of the beam prediction model may include a beam identifier of the candidate optimal beam. The terminal determines, according to the beam identifier of the candidate optimal beam, the optimal beam from the candidate optimal beams output by the beam prediction model. The beam identifier may be, for example, a beam ID, such as, at least one of a candidate optimal transmission beam ID, a candidate optimal reception beam ID, and a candidate optimal beam pair ID.

In some embodiments, the output of the beam prediction model may include the beam quality of the candidate optimal beam, and the beam quality may include, for example, L1-RSRP and/or L1-SINR.

In the present disclosure, when the output of the beam prediction model includes the candidate optimal beams, the optimal beam can be determined from the candidate optimal beams based on the number of reception beams supported by the terminal, so that terminals supporting different numbers of reception beams can use the same beam prediction model to determine the optimal beam suitable for each terminal.

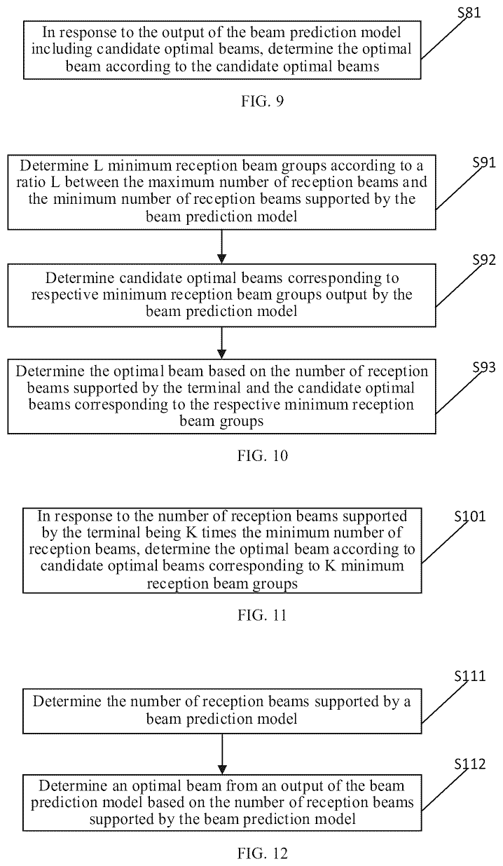

In the method for determining the beam provided in embodiments of the present disclosure, FIG. 10 shows a flowchart of another method for determining a beam according to an embodiment of the present disclosure. As shown in FIG. 10, determining the optimal beam according to the candidate optimal beams in the S81 may include steps S91 to S93.

In the step S91, L minimum reception beam groups are determined according to a ratio L between the maximum number of reception beams and a minimum number of reception beams supported by the beam prediction model.

In some embodiments, the terminal may determine the L minimum reception beam groups according to the ratio L between the maximum number of reception beams and the minimum number of reception beams supported by the beam prediction model, and each minimum reception beam group corresponds to a plurality of beam pairs.

For example, if the maximum number of reception beams supported by the beam prediction model is 8, and the minimum number of reception beams supported by the beam prediction model is 2, then L can be determined to be 4, that is, 4 minimum reception beam groups are determined. Each minimum reception beam group can include the plurality of beam pairs. The plurality of beam pairs included in all minimum reception beam groups constitute the maximum number of beam pairs supported by the beam prediction model.

In the step S92, candidate optimal beams corresponding to respective minimum reception beam groups output by the beam prediction model are determined.

In some embodiments, the terminal determines the candidate optimal beams corresponding to the respective minimum reception beam groups output by the beam prediction model. In other words, the terminal can determine the candidate optimal beams corresponding to each minimum reception beam group.

In the step S93, the optimal beam is determined based on the number of reception beams supported by the terminal and the candidate optimal beams corresponding to the respective minimum reception beam groups.

In some embodiments, the terminal may determine the optimal beam based on the number of reception beams supported by the terminal and the candidate optimal beams corresponding to the respective minimum reception beam groups.

For example, when the number of reception beams supported by the terminal is greater than or equal to the minimum number of reception beams, the terminal can determine the optimal beam based on the candidate optimal beams corresponding to some or all of the minimum reception beam groups. For example, the minimum number of reception beams supported by the beam prediction model is 2, the maximum number of reception beams supported by the beam prediction model is 8, and the number of the minimum reception beam group is 4. When the number of reception beams supported by the terminal is 2, the optimal beam can be determined based on the candidate optimal beams corresponding to one minimum reception beam group, that is, the candidate optimal beams corresponding to one minimum reception beam group are determined as the optimal beam. When the number of reception beams supported by the terminal is 4, the optimal beam can be determined based on the candidate optimal beams corresponding to 2 minimum reception beam groups, that is, the candidate optimal beams corresponding to two of the minimum reception beam groups are determined as the optimal beam. When the number of reception beams supported by the terminal is 8, the optimal beam can be determined based on the candidate optimal beams corresponding to all minimum reception beam groups, that is, the candidate optimal beams corresponding to all the minimum reception beam groups are determined as the optimal beam.

In the present disclosure, when the output of the beam prediction model includes the candidate optimal beams, the maximum number of beam pairs supported by the beam prediction model can be divided into the plurality of minimum reception beam groups according to the maximum number of reception beams and the minimum number of reception beams supported by the beam prediction model, so as to determine the optimal beam based on the number of reception beams supported by the terminal and using the candidate optimal beams corresponding to one or more minimum reception beam groups, so that terminals supporting different numbers of reception beams can use the same beam prediction model to determine the optimal beam suitable for each terminal.

In the method for determining the beam provided in embodiments of the present disclosure, the minimum reception beam group corresponding to the plurality of beam pairs can satisfy any of: numbers of beam pairs in each minimum reception beam group being continuous; beam pairs corresponding to the same reception beam belonging to the same minimum reception beam group; or the beam pairs corresponding to the same reception beam being divided into L sub-groups, and the L sub-groups and the L minimum reception beam groups being in one-to-one correspondence.

In some embodiments, numbers of the beam pairs in each minimum reception beam group are continuous.

For example, when the minimum reception beam groups are divided based on L, the numbers of the plurality of beam pairs corresponding to each minimum reception beam group are continuous. For example, the maximum number of beam pairs is 32 beam pairs, and L is 4, that is, 4 minimum reception beam groups. Then the 32 beam pairs can be divided into 4 groups according to the beam pairs, and each group can include 8 beam pairs. The numbers of the 8 beam pairs in each group are continuous. In some embodiments, the beam pair number can be a beam pair ID.

In some embodiments, numbers of the beam pairs within each minimum reception beam group are discontinuous.

For example, when the minimum reception beam groups are divided based on L, the numbers of the plurality of beam pairs corresponding to each minimum reception beam group are discontinuous. For example, the maximum number of beam pairs is 32 beam pairs, and L is 4, that is, 4 minimum reception beam groups. Then the 32 beam pairs can be divided into 4 groups according to the beam pairs, and each group can include 8 beam pairs. The numbers of the 8 beam pairs in each group are discontinuous. For example, the numbers of group 1 can be 1, 5, 9, 13, 17, 21, 25, 29; the numbers of group 2 can be 2, 6, 10, 14, 18, 22, 26, 30; the numbers of group 3 can be 3, 7, 11, 15, 19, 23, 27, 31; and the numbers of group 4 can be 4, 8, 12, 16, 20, 24, 28, 32.

In some embodiments, beam pairs corresponding to the same reception beam belong to the same minimum reception beam group.

For example, when the minimum reception beam groups are divided based on L, the beam pairs corresponding to the same reception beam can be divided into the same minimum reception beam group. For example, the maximum number of beam pairs is 32 beam pairs, and L is 4, that is, 4 minimum reception beam groups. The 32 beams can be divided into 4 minimum reception beam groups. It can be understood that the beam pairs corresponding to the same reception beam belong to the same minimum reception beam group. It can be understood that the beam pairs contained in each of the 4 minimum reception beam groups can correspond to one or more reception beam groups. For example, the beam pairs contained in any minimum reception beam group correspond to the same reception beam, or any minimum reception beam group can contain beam pairs corresponding to a plurality of reception beams. However, it should be noted that the beam pairs corresponding to the same reception beam should belong to the same group. In addition, the value of L should be less than or equal to the maximum number of reception beams supported by the model.

In some embodiments, beam pairs corresponding to the same reception beam are divided into L sub-groups, and the L sub-groups and the L minimum reception beam groups are in the one-to-one correspondence.

For example, when the minimum reception beam groups are divided based on L, the beam pairs corresponding to the same reception beam can be divided into L sub-groups. The L sub-groups and the L minimum reception beam groups are in the one-to-one correspondence. Then the L minimum reception beam groups can be composed based on the L sub-groups corresponding to each reception beam. Assuming that the maximum number of beam pairs is 32 beam pairs, L is 4, that is, 4 minimum reception beam groups, and the number of reception beams supported by the beam prediction model is 8. Then the beam pairs corresponding to each reception beam can be divided into 4 sub-groups. The 4 minimum reception beam groups can be composed of 8 sub-groups corresponding to respective reception beams. For example, the beam pairs of reception beam 1 is divided into sub-group 11′, sub-group 12′, sub-group 13′, and sub-group 14′; the beam pairs of reception beam 2 is divided into sub-group 21′, sub-group 22′, sub-group 23′, and sub-group 24′; . . . ; the beam pairs of reception beam 8 is divided into sub-group 81′, sub-group 82′, sub-group 83′, and sub-group 84′. The minimum reception beam group 1 can be composed of sub-group 11′, sub-group 21′, . . . , sub-group 81′; the minimum reception beam group 2 can be composed of sub-group 12′, sub-group 22′, . . . , sub-group 82′; the minimum reception beam group 3 can be composed of sub-group 13′, sub-group 23′, . . . , sub-group 83′; and the minimum reception beam group 4 can be composed of sub-group 14′, sub-group 24′, . . . , sub-group 84′.

The present disclosure provides a plurality of different ways of forming minimum reception beam groups, so that when the output of the beam prediction model includes the candidate optimal beams, the optimal beam can be determined based on the number of reception beams supported by the terminal and the candidate optimal beams corresponding to the minimum reception beam group. Therefore, terminals supporting different numbers of reception beams can use the same beam prediction model to determine the optimal beam suitable for each terminal.

In the method for determining the beam provided in embodiments of the present disclosure, FIG. 11 shows a flowchart of yet another method for determining a beam according to an embodiment of the present disclosure. As shown in FIG. 11, determining the optimal beam based on the number of reception beams supported by the terminal and the candidate optimal beams corresponding to respective minimum reception beam groups in the S93 may include a step S101.

In the step S101, in response to the number of reception beams supported by the terminal being K times the minimum number of reception beams, the optimal beam is determined according to candidate optimal beams corresponding to K minimum reception beam groups.

In some embodiments, when the number of reception beams supported by the terminal is K times the minimum number of reception beams, the terminal may determine the optimal beam according to the candidate optimal beams corresponding to the K minimum reception beam groups, that is, the candidate optimal beams corresponding to the K minimum reception beam groups are determined as the optimal beam. K is a positive integer, and the number of reception beams supported by the terminal is less than or equal to the maximum number of reception beams.

For example, if the minimum number of reception beams supported by the beam prediction model is 2, and the maximum number of reception beams supported by the beam prediction model is 8, when the number of reception beams supported by the terminal is 2, it is obvious that K is 1. The terminal can determine the optimal beam based on the candidate optimal beams corresponding to any one of the minimum reception beam groups, that is, the candidate optimal beams corresponding to one of the minimum reception beam groups are determined as the optimal beam. In addition, one of the minimum reception beam groups is the minimum reception beam group corresponding to the 2 reception beams supported by the terminal. When the number of reception beams supported by the terminal is 4, it is obvious that K is 2. The terminal can determine the optimal beam based on the candidate optimal beams corresponding to any two minimum reception beam groups, that is, the candidate optimal beams corresponding to any two minimum reception beam groups are determined as the optimal beam. In addition, the any two minimum reception beam groups are the minimum reception beam groups corresponding to the 4 reception beams supported by the terminal. When the number of reception beams supported by the terminal is 8, it is obvious that K is 4. In this case, the number of the minimum reception beam groups is also 4, so the terminal can determine the optimal beam according to the candidate optimal beams corresponding to all the minimum reception beam groups, that is, the candidate optimal beams corresponding to all the minimum reception beam groups are determined as the optimal beam.

For example, the number of reception beams supported by the terminal is the maximum number Rx_num of reception beams supported by the beam quality prediction model. Then the terminal determines the optimal beam according to the candidate optimal beams corresponding to all the minimum reception beam groups.

For example, the number of reception beams supported by the terminal is

$$\frac{Rx\_num}{2} .$$

Then the terminal can determine the optimal beam according to the candidate optimal beams corresponding to half of all the minimum reception beam groups. It can be understood that, assuming that the maximum number Rx_num of reception beams supported by the beam prediction model is 8, the minimum reception beam supported by the beam prediction model is 2, the number of reception beams supported by the terminal is 4, and the number of minimum reception beam groups is 4. It can be understood that half of all the minimum reception beam groups are 2 minimum reception beam groups, and K is 2. Assuming that the maximum number Rx_num of reception beams supported by the beam prediction model is 8, the minimum number of reception beams supported by the beam prediction model is 1, the number of reception beams supported by the terminal is 4, and the number of minimum reception beam groups is 8. It can be understood that half of all the minimum reception beam groups are 4 minimum reception beam groups, and K is 4.

For example, beam pair identifiers of a plurality of beam pairs corresponding to the half of the minimum reception beam groups may be continuous. For example, the half of the minimum reception beam groups corresponds to continuous reception beams. Assuming that the maximum number of reception beams is 8, the half of the minimum reception beam groups may correspond to the first half of the reception beams, that is, reception beam 1, reception beam 2, reception beam 3, and reception beam 4. The plurality of beam pairs corresponding to the half of the minimum reception beam groups are all beam pairs corresponding to reception beam 1, all beam pairs corresponding to reception beam 2, all beam pairs corresponding to reception beam 3, and all beam pairs corresponding to reception beam 4. The other half of the minimum reception beam groups may correspond to the second half of the reception beams, that is, reception beam 5, reception beam 6, reception beam 7, and reception beam 8. The plurality of beam pairs corresponding to the other half of the minimum reception beam groups are all beam pairs corresponding to reception beam 5, all beam pairs corresponding to reception beam 6, all beam pairs corresponding to reception beam 7, and all beam pairs corresponding to reception beam 8.

For another example, beam pair identifiers of a plurality of beam pairs corresponding to the half of the minimum reception beam groups may be discontinuous. For example, the plurality of beam pairs corresponding to the half of the minimum reception beam groups are beam pairs with odd or even numbers among beam pairs corresponding to all reception beams.

For yet another example, the reception beams corresponding to the half of the minimum reception beam groups may be discontinuous reception beams. Assuming that the maximum number of reception beams supported by the beam prediction model is 8, the half of the minimum reception beam groups may correspond to reception beam 1, reception beam 3, reception beam 5, and reception beam 7. The plurality of beam pairs corresponding to the half of the minimum reception beam groups are all beam pairs corresponding to reception beam 1, all beam pairs corresponding to reception beam 3, all beam pairs corresponding to reception beam 5, and all beam pairs corresponding to reception beam 7. The other half of the minimum reception beam groups may correspond to reception beam 2, reception beam 4, reception beam 6, and reception beam 8. The plurality of beam pairs corresponding to the other half of the minimum reception beam groups are all beam pairs corresponding to reception beam 2, all beam pairs corresponding to reception beam 4, all beam pairs corresponding to reception beam 6, and all beam pairs corresponding to reception beam 8.

For example, the number of reception beams supported by the terminal is

$$\frac{Rx\_num}{4} .$$

Then the terminal can determine the optimal beam according to the candidate optimal beams corresponding to one quarter of all the minimum reception beam groups. It can be understood that, assuming that the maximum number Rx_num of reception beams supported by the beam prediction model is 8, the minimum number of reception beams supported by the beam prediction model is 2, the number of reception beams supported by the terminal is 2, and the number of minimum reception beam groups is 4. It can be understood that one quarter of all the minimum reception beam groups is 1 minimum reception beam group, and K is 1. Assuming that the maximum number Rx_num of reception beams supported by the beam prediction model is 8, the minimum number of reception beams supported by the beam prediction model is 1, the number of reception beams supported by the terminal is 2, and the number of minimum reception beam groups is 8. It can be understood that one quarter of all the minimum reception beam groups is 2 minimum reception beam groups, and K is 2.

For example, beam pair identifiers of a plurality of beam pairs corresponding to one quarter of the minimum reception beam groups may be continuous. For example, one quarter of the minimum reception beam groups corresponds to continuous reception beams. Assuming that the maximum number of reception beams supported by the beam prediction model is 8 and the minimum number of reception beams supported by the beam prediction model is 2, the minimum reception beam groups may correspond to reception beam 1 and reception beam 2, reception beam 3 and reception beam 4, reception beam 5 and reception beam 6, and reception beam 7 and reception beam 8. The plurality of beam pairs corresponding to respective minimum reception beam groups may be all beam pairs corresponding to reception beam 1 and all beam pairs corresponding to reception beam 2, all beam pairs corresponding to reception beam 3 and all beam pairs corresponding to reception beam 4, all beam pairs corresponding to reception beam 5 and all beam pairs corresponding to reception beam 6, all beam pairs corresponding to reception beam 7 and all beam pairs corresponding to reception beam 8.

For another example, the beam pair identifiers of the plurality of beam pairs corresponding to the one quarter of minimum reception beam groups may be discontinuous. Still taking the example that the maximum number of reception beams supported by the beam prediction model is 8, and the minimum number of reception beams supported by the beam prediction model is 2, the number of minimum reception beam groups is 4, and the beam pairs corresponding to each reception beam can be divided into 4 sub-groups. For example, the plurality of beam pairs corresponding to reception beam 1 are divided into sub-group 11″, sub-group 12″, sub-group 13″ and sub-group 14″; the plurality of beam pairs corresponding to reception beam 2 are divided into sub-group 21″, sub-group 22″, sub-group 23″ and sub-group 24″; . . . ; the plurality of beam pairs corresponding to reception beam 8 are divided into sub-group 81″, sub-group 82″, sub-group 83″ and sub-group 84″. Then the plurality of beam pairs corresponding to the minimum reception beam group 1 can be composed of sub-group 11″, sub-group 21″, . . . , sub-group 81″; the plurality of beam pairs corresponding to the minimum reception beam group 2 can be composed of sub-group 12″, sub-group 22″, . . . , sub-group 82″; the plurality of beam pairs corresponding to the minimum reception beam group 3 can be composed of sub-group 13″, sub-group 23″, . . . , sub-group 83″; the plurality of beam pairs corresponding to the minimum reception beam group 4 can be composed of sub-group 14″, sub-group 24″, . . . , sub-group 84″. Obviously, the beam pair identifiers of the plurality of beam pairs corresponding to each minimum reception beam group are discontinuous.

For another example, the reception beams corresponding to one quarter of the minimum reception beam groups may be discontinuous reception beams. Assuming that the maximum number of reception beams supported by the beam prediction model is 8 and the minimum number of reception beams supported by the beam prediction model is 2, the minimum reception beam groups may correspond to reception beam 1 and reception beam 5, reception beam 2 and reception beam 6, reception beam 3 and reception beam 7, and reception beam 4 and reception beam 8. The plurality of beam pairs corresponding to the minimum reception beam group may be all beam pairs corresponding to reception beam 1 and all beam pairs corresponding to reception beam 5, all beam pairs corresponding to reception beam 2 and all beam pairs corresponding to reception beam 6, all beam pairs corresponding to reception beam 3 and all beam pairs corresponding to reception beam 7, and all beam pairs corresponding to reception beam 4 and all beam pairs corresponding to reception beam 8. Alternatively, the minimum reception beam groups may correspond to discontinuous reception beams such as reception beam 1 and reception beam 3, reception beam 2 and reception beam 4, reception beam 5 and reception beam 7, and reception beam 6 and reception beam 8. Accordingly, the plurality of beam pairs corresponding to the minimum reception beam group may be all beam pairs corresponding to the respective reception beams.

It can be understood that if the second indication information sent by the network device directly indicates the optimal beam, the network device can also determine the optimal beam using the above methods of FIGS. 6 to 11.

In the present disclosure, the optimal beam can be determined based on the different numbers of reception beams supported by the terminal combined with the candidate optimal beams corresponding to the minimum reception beam group, so that terminals supporting different numbers of reception beams can use the same beam prediction model to determine the optimal beam suitable for each terminal.

Based on the same concept, the present disclosure also provides a method for determining a beam performed on a network device side.

FIG. 12 shows a flowchart of another method for determining a beam according to an embodiment of the present disclosure. As shown in FIG. 12, the method is applied to a network device and may include steps S111 and S112.

In the step S111, the number of reception beams supported by a beam prediction model is determined.

In some embodiments, the network device may determine the number of reception beams supported by the beam prediction model.

In the step S112, an optimal beam is determined from an output of the beam prediction model based on the number of reception beams supported by the beam prediction model.

In some embodiments, the network device may determine the optimal beam from the output of the beam prediction model based on the number of reception beams supported by the beam prediction model determined in the S111.

In some embodiments, the optimal beam may be a beam with the best beam quality when the network device communicates. The optimal beam may include at least one of an optimal transmission beam, an optimal reception beam, and an optimal beam pair. The optimal beam pair includes a transmission beam and a reception beam.

In some embodiments, the optimal beam may include one optimal beam or a plurality of optimal beams.

In the present disclosure, the optimal beam can be determined from the output of the beam prediction model through the number of reception beams supported by the beam prediction model, so that terminals supporting different numbers of reception beams can use the same beam prediction model to determine the optimal beam suitable for each terminal.

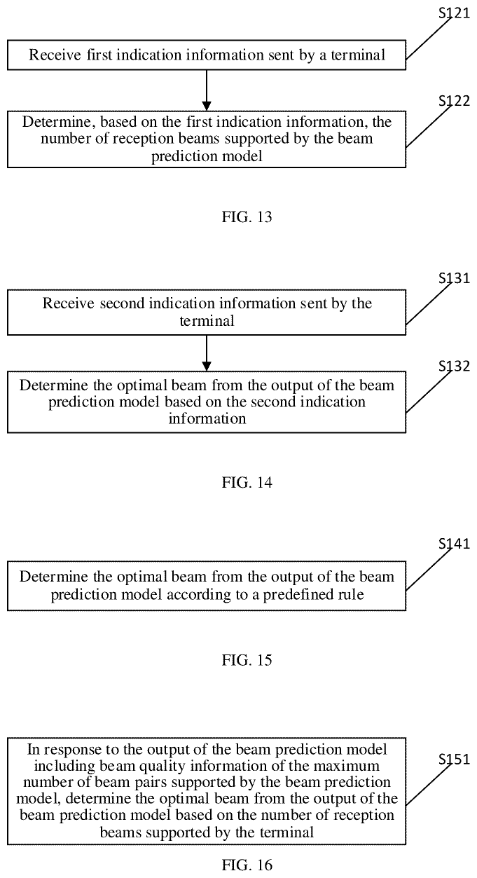

In the method for determining the beam provided in embodiments of the present disclosure, FIG. 13 shows a flowchart of yet another method for determining a beam according to an embodiment of the present disclosure. As shown in FIG. 13, determining the number of reception beams supported by the beam prediction model in the S111 may include steps S121 and S122.

In the step S121, first indication information sent by a terminal is received.

In some embodiments, the network device may receive the first indication information sent by the terminal, and the first indication information is used to indicate the number of reception beams supported by the beam prediction model.

In the step S122, the number of reception beams supported by the beam prediction model is determined based on the first indication information.

In some embodiments, the network device may determine, based on the first indication information received in the S121, the number of reception beams supported by the beam prediction model.

In the present disclosure, the number of reception beams supported by the beam prediction model can also be determined through the indication information from another device, so as to determine the optimal beam from the output of the beam prediction model based on the number of reception beams supported by the beam prediction model, so that terminals supporting different numbers of reception beams can use the same beam prediction model to determine the optimal beam suitable for each terminal.

In the method for determining the beam provided in embodiments of the present disclosure, the number of reception beams supported by the beam prediction model may include: a maximum number of reception beams supported by the beam prediction model; or one or more numbers of reception beams supported by the beam prediction model.

In some embodiments, the number of reception beams that the beam prediction model can support may be the maximum number of reception beams supported by the beam prediction model, for example, denoted as Rx_num.

In some embodiments, the number of reception beams that the beam prediction model can support can be one or more numbers of reception beams. For example, the beam prediction model can support one or more different numbers of reception beams, and the one or more numbers of reception beams can correspond to one number of reception beams or a plurality of different numbers of reception beams that the beam prediction model can support.

In the present disclosure, the optimal beam is determined from the output of the beam prediction model through the number of reception beams that the beam prediction model can support, so that terminals supporting different numbers of reception beams can use the same beam prediction model to determine the optimal beam suitable for each terminal.

In the method for determining the beam provided in embodiments of the present disclosure, in response to the beam prediction model supporting the plurality of numbers of reception beams, the plurality of numbers of reception beams may include a first number and a second number. The first number is the maximum number of reception beams supported by the beam prediction model, the first number is N times the second number, the minimum value of the second number is 1, and N is a positive integer.

In some embodiments, the beam prediction model may support the plurality of numbers of reception beams. The plurality of numbers of reception beams may include the first number representing the maximum number of reception beams supported by the beam prediction model. It should be understood that the first number may be Rx_num. The plurality of numbers of reception beams may include the second number, the first number is N times the second number, the minimum value of the second number is 1, and N is the positive integer.

In some embodiments, the first number may be 2″ times the second number, where n is a non-negative integer.

In the present disclosure, the beam prediction model can support the plurality of different numbers of reception beams, so that terminals supporting different numbers of reception beams can use the same beam prediction model to determine the optimal beam suitable for each terminal.

In the method for determining the beam provided in embodiments of the present disclosure, determining the optimal beam from the output of the beam prediction model includes: receiving second indication information sent by the terminal, and determining the optimal beam from the output of the beam prediction model based on the second indication information; or, determining the optimal beam from the output of the beam prediction model according to a predefined rule.

In some embodiments, FIG. 14 shows a flowchart of still another method for determining a beam according to an embodiment of the present disclosure. As shown in FIG. 14, determining the optimal beam from the output of the beam prediction model in the S112 may include steps S131 and S132.

In the step S131, second indication information sent by the terminal is received.

In some embodiments, the network device may receive the second indication information sent by the terminal, and the second indication information is used to indicate the optimal beam.

It can be understood that the network device can use the beam prediction model to predict the optimal beam, and the network device indicates the predicted optimal beam to the terminal through the second indication information.

In the step S132, the optimal beam is determined from the output of the beam prediction model based on the second indication information.

In some embodiments, the network device may determine the optimal beam from the output of the beam prediction model based on the second indication information received in the S131.

In some embodiments, FIG. 15 shows a flowchart of another method for determining a beam according to an embodiment of the present disclosure.

In a step S141, the optimal beam is determined from the output of the beam prediction model according to a predefined rule.

In some embodiments, the network device may determine the optimal beam from the output of the beam prediction model according to the predefined rule.

It can be understood that one case may be that the optimal beam is predicted by using the beam prediction model on the terminal, and the network device may determine the beam identifier range corresponding to the optimal beam by using the predefined rule or the indication information of the terminal, and determine the optimal beam from the beams within the beam identifier range corresponding to the optimal beam. The network device may also determine the beam quality corresponding to the optimal beam by using the indication information of the terminal, and determine the optimal beam. Alternatively, another case may be that the optimal beam is predicted by using the beam prediction model on the network device, and the network device may determine, by using the predefined rule, the optimal beam from beams output by the beam prediction model.

In the present disclosure, the optimal beam can be determined from the output of the beam prediction model through the indication information of the terminal or the predefined rule, so that terminals supporting different numbers of reception beams can use the same beam prediction model to determine the optimal beam suitable for each terminal.

In the method for determining the beam provided in embodiments of the present disclosure, FIG. 16 shows a flowchart of yet another method for determining a beam according to an embodiment of the present disclosure. As shown in FIG. 16, determining the optimal beam from the output of the beam prediction model in the S132 or S141 may include a step S151.

In the step S151, in response to the output of the beam prediction model including beam quality information of a maximum number of beam pairs supported by the beam prediction model, the optimal beam is determined from the output of the beam prediction model based on the number of reception beams supported by the terminal.

In some embodiments, in response to the output of the beam prediction model including the beam quality information of the maximum number of beam pairs supported by the beam prediction model, such as reference signal received powers (RSRPs) and/or signal to interference plus noise ratios (SINRs) of the maximum number of beam pairs, where the maximum number may be the product of the number Tx_num of transmission beams of the network device and the maximum number Rx_num of reception beams supported by the beam prediction model, that is, Tx_num×Rx_num, the network device may determine the optimal beam from the output of the beam prediction model based on the number of reception beams supported by the terminal. That is, the network device may determine, based on the number of reception beams supported by the terminal, the optimal beam from the beam quality information of the maximum number of beam pairs.

In the present disclosure, when the output of the beam prediction model includes the beam quality information of the maximum number of beam pairs supported by the beam prediction model, the optimal beam can be determined from the output of the beam prediction model based on the number of reception beams supported by the terminal, so that terminals supporting different numbers of reception beams can use the same beam prediction model to determine the optimal beam suitable for each terminal.

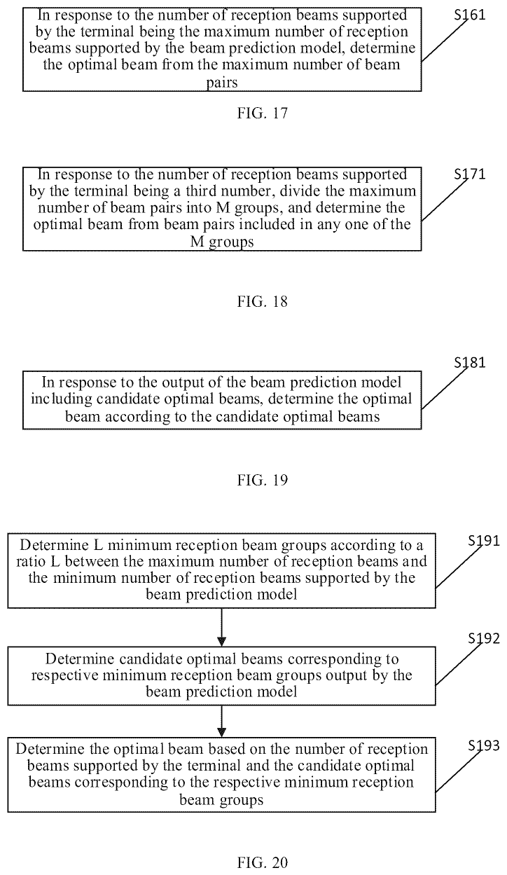

In the method for determining the beam provided in embodiments of the present disclosure, FIG. 17 shows a flowchart of still another method for determining a beam according to an embodiment of the present disclosure. As shown in FIG. 17, determining the optimal beam from the output of the beam prediction model based on the number of reception beams supported by the terminal in the S151 may include a step S161.

In the step S161, in response to the number of reception beams supported by the terminal being the maximum number of reception beams supported by the beam prediction model, the optimal beam is determined from the maximum number of beam pairs.

In some embodiments, if the number of reception beams supported by the terminal is the maximum number of reception beams supported by the beam prediction model, the network device can determine the optimal beam from the maximum number of beam pairs.

It can be understood that how to determine the one or more beam pairs with the best beam quality can be realized using the existing methods. For example, when the beam quality meets the corresponding conditions, the beam quality of the corresponding beam pair can be considered to be the best. The specific conditions can be set accordingly based on actual conditions, which are not limited by the present disclosure.

In the present disclosure, when the number of reception beams supported by the terminal is the maximum number of reception beams supported by the beam prediction model, the optimal beam can be determined from the maximum number of beam pairs output by the beam prediction model, so that the beam prediction model can adapt to the terminal whose number of reception beams is the maximum number of reception beams supported by the beam prediction model.

In the method for determining the beam provided in embodiments of the present disclosure, FIG. 18 shows a flowchart of another method for determining a beam according to an embodiment of the present disclosure. As shown in FIG. 18, determining the optimal beam from the output of the beam prediction model based on the number of reception beams supported by the terminal in the S151 may include a step S171.

In the step S171, in response to the number of reception beams supported by the terminal being a third number, the maximum number of beam pairs are divided into M groups, and the optimal beam is determined from beam pairs included in any one of the M groups.

In some embodiments, if the number of reception beams supported by the terminal is the third number, the maximum number of beam pairs may be divided into the M groups. The network device determines the optimal beam from the beam pairs included in any one of the M groups. The third number is 1/M of the maximum number of reception beams supported by the beam prediction model, and M is a positive integer.

In some embodiments, M is 2, then the third number is

$$\frac{Rx\_num}{2} .$$

The maximum number of beam pairs can be divided into 2 groups, and the network device determines the optimal beam from the

$$\frac{Tx\_num \times Rx\_num}{2}$$

beam pairs contained in any one of the 2 groups. In other words, the network device determines the optimal beam from any half of the maximum number of beam pairs.

In some embodiments, M is 4, then the third number is

$$\frac{Rx\_num}{4} .$$

The maximum number of beam pairs can be divided into 4 groups, and the network device determines the optimal beam from the

$$\frac{Tx\_num \times Rx\_num}{4}$$

beam pairs contained in any one of the 4 groups. In other words, the network device determines the optimal beam from one quarter of the maximum number of beam pairs.

In some embodiments, M is 2^{n′}, where n′ is a non-negative integer. For example, the third number is

$$\frac{Rx\_num}{2} , \frac{Rx\_num}{4} , \frac{Rx\_num}{8}$$

and so on.

In some embodiments, the minimum value of the third number may be 1, that is, M is equal to Rx_num. Accordingly, dividing the maximum number of beam pairs into the M groups may be dividing the maximum number of beam pairs into Rx_num groups.

It can be understood that the above is only an illustrative description, and the present disclosure does not limit the value of M. The specific value of M can be selected according to actual conditions.

In the present disclosure, when the number of reception beams supported by the terminal is within the maximum number of reception beams supported by the beam prediction model, the maximum number of beam pairs is grouped, and the optimal beam is determined from a plurality of beam pairs in any group, so that the beam prediction model can adapt to the terminal whose number of reception beams is within the maximum number of reception beams supported by the beam prediction model.

In the method for determining the beam provided in embodiments of the present disclosure, dividing the maximum number of beam pairs into the M groups in the S171 may include at least one of: dividing the maximum number of beam pairs into the M groups according to the beam pairs, and numbers of beam pairs in each group are continuous or discontinuous; dividing the maximum number of beam pairs into the M groups according to reception beams corresponding to the beam pairs, and beam pairs corresponding to the same reception beam belong to the same group; or dividing the maximum number of beam pairs into the M groups, beam pairs corresponding to the same reception beam are divided into M sub-groups, and the M sub-groups and the M groups are in one-to-one correspondence.

In some embodiments, dividing the maximum number of beam pairs into the M groups may be: dividing the maximum number of beam pairs into the M groups according to the beam pairs, and the numbers of the beam pairs in each group are continuous.

In some embodiments, dividing the maximum number of beam pairs into the M groups may be: dividing the maximum number of beam pairs into the M groups according to the beam pairs, and the numbers of the beam pairs in each group are discontinuous.

In some embodiments, the maximum number of beam pairs are divided into the M groups according to the reception beams corresponding to the beam pairs, and the beam pairs corresponding to the same reception beam belong to the same group.

It can be understood that if the reception beam is the reception beam of the terminal and the transmission beam is the transmission beam of the network device, the number of beam pairs corresponding to each reception beam should be the same as the number Tx_num of transmission beams of the network device.

In some embodiments, the maximum number of beam pairs are divided into the M groups, the beam pairs corresponding to the same reception beam are divided into M sub-groups, and the M sub-groups and the M groups are in the one-to-one correspondence.

It can be understood that the numbers of the plurality of beam pairs corresponding to each sub-group can be continuous or discontinuous.

The present disclosure provides a variety of different ways to group the maximum number of beam pairs, so that when the number of reception beams supported by the terminal is within the maximum number of reception beams supported by the beam prediction model, the optimal beam can be determined from the plurality of beam pairs in any group, and then the beam prediction model can adapt to the terminal whose number of reception beams is within the maximum number of reception beams supported by the beam prediction model.

In the method for determining the beam provided in embodiments of the present disclosure, FIG. 19 shows a flowchart of yet another method for determining a beam according to an embodiment of the present disclosure. As shown in FIG. 19, determining the optimal beam from the output of the beam prediction model in the S132 or S141 may include a step S181.

In the step S181, in response to the output of the beam prediction model including candidate optimal beams, the optimal beam is determined according to the candidate optimal beams.

In some embodiments, the beam prediction model may directly output the candidate optimal beams, and the network device may determine the optimal beam from the candidate optimal beams output by the beam prediction model.

In some embodiments, the output of the beam prediction model may include a beam identifier of the candidate optimal beam. The network device determines, according to the beam identifier of the candidate optimal beam, the optimal beam from the candidate optimal beams output by the beam prediction model. The beam identifier may be, for example, a beam ID, such as, at least one of a candidate optimal transmission beam ID, a candidate optimal reception beam ID, and a candidate optimal beam pair ID.

In some embodiments, the output of the beam prediction model may include the beam quality of the candidate optimal beam, and the beam quality may include, for example, L1-RSRP and/or L1-SINR.

In the present disclosure, when the output of the beam prediction model includes the candidate optimal beams, the optimal beam can be determined from the candidate optimal beams based on the number of reception beams supported by the terminal, so that terminals supporting different numbers of reception beams can use the same beam prediction model to determine the optimal beam suitable for each terminal.

In the method for determining the beam provided in embodiments of the present disclosure, FIG. 20 shows a flowchart of still another method for determining a beam according to an embodiment of the present disclosure. As shown in FIG. 20, determining the optimal beam according to the candidate optimal beams in the S181 may include steps S191 to S193.

In the step S191, L minimum reception beam groups are determined according to a ratio L between the maximum number of reception beams and a minimum number of reception beams supported by the beam prediction model.

In some embodiments, the network device may determine the L minimum reception beam groups according to the ratio L between the maximum number of reception beams and the minimum number of reception beams supported by the beam prediction model, and each minimum reception beam group corresponds to a plurality of beam pairs.

In the step S192, candidate optimal beams corresponding to respective minimum reception beam groups output by the beam prediction model are determined.

In some embodiments, the network device determines the candidate optimal beams corresponding to the respective minimum reception beam groups output by the beam prediction model. In other words, the network device can determine the candidate optimal beams corresponding to each minimum reception beam group.

In the step S193, the optimal beam is determined based on the number of reception beams supported by the terminal and the candidate optimal beams corresponding to the respective minimum reception beam groups.

In some embodiments, the network device may determine the optimal beam based on the number of reception beams supported by the terminal and the candidate optimal beams corresponding to the respective minimum reception beam groups.

In the present disclosure, when the output of the beam prediction model includes the candidate optimal beams, the maximum number of beam pairs supported by the beam prediction model can be divided into the plurality of minimum reception beam groups according to the maximum number of reception beams and the minimum number of reception beams supported by the beam prediction model, so as to determine the optimal beam based on the number of reception beams supported by the terminal and using the candidate optimal beams corresponding to one or more minimum reception beam groups, so that terminals supporting different numbers of reception beams can use the same beam prediction model to determine the optimal beam suitable for each terminal.

In the method for determining the beam provided in embodiments of the present disclosure, the minimum reception beam group corresponding to the plurality of beam pairs can satisfy any of: numbers of beam pairs in each minimum reception beam group being continuous; beam pairs corresponding to the same reception beam belonging to the same minimum reception beam group; or the beam pairs corresponding to the same reception beam being divided into L sub-groups, and the L sub-groups and the L minimum reception beam groups being in one-to-one correspondence.

In some embodiments, numbers of the beam pairs in each minimum reception beam group are continuous.

In some embodiments, numbers of the beam pairs within each minimum reception beam group are discontinuous.

In some embodiments, beam pairs corresponding to the same reception beam belong to the same minimum reception beam group.

In some embodiments, beam pairs corresponding to the same reception beam are divided into L sub-groups, and the L sub-groups and the L minimum reception beam groups are in the one-to-one correspondence.

The present disclosure provides a plurality of different ways of forming minimum reception beam groups, so that when the output of the beam prediction model includes the candidate optimal beams, the optimal beam can be determined based on the number of reception beams supported by the terminal and the candidate optimal beams corresponding to the minimum reception beam group. Therefore, terminals supporting different numbers of reception beams can use the same beam prediction model to determine the optimal beam suitable for each terminal.

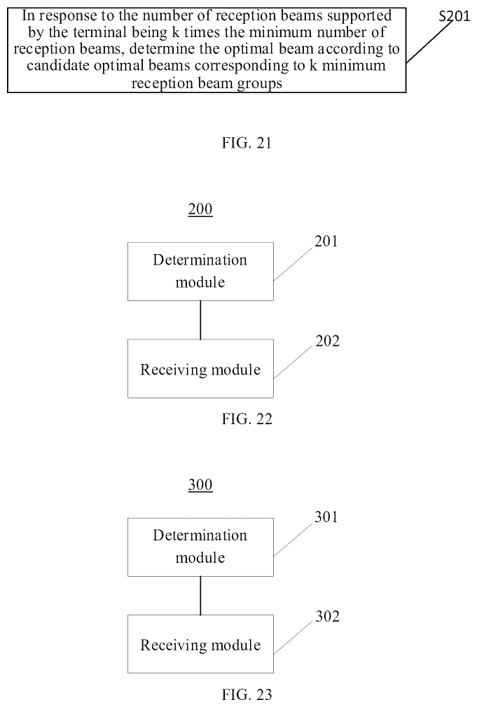

In the method for determining the beam provided in embodiments of the present disclosure, FIG. 21 shows a flowchart of another method for determining a beam according to an embodiment of the present disclosure. As shown in FIG. 21, determining the optimal beam based on the number of reception beams supported by the terminal and the candidate optimal beams corresponding to respective minimum reception beam groups in the S193 may include a step S201.

In the step S201, in response to the number of reception beams supported by the terminal being K times the minimum number of reception beams, the optimal beam is determined according to candidate optimal beams corresponding to K minimum reception beam groups.

In some embodiments, when the number of reception beams supported by the terminal is K times the minimum number of reception beams, the network device may determine the optimal beam according to the candidate optimal beams corresponding to the K minimum reception beam groups, that is, the candidate optimal beams corresponding to the K minimum reception beam groups are determined as the optimal beam. K is a positive integer, and the number of reception beams supported by the terminal is less than or equal to the maximum number of reception beams.

It can be understood that if the second indication information sent by the terminal directly indicates the optimal beam, the terminal can also determine the optimal beam using the above methods of FIGS. 16 to 21.

In the present disclosure, the optimal beam can be determined based on the different numbers of reception beams supported by the terminal combined with the candidate optimal beams corresponding to the minimum reception beam group, so that terminals supporting different numbers of reception beams can use the same beam prediction model to determine the optimal beam suitable for each terminal.

It can be understood that specific implementation processes of corresponding step embodiments of the method for determining the beam implemented on the network device side in FIGS. 12 to 21 can refer to the corresponding description on the terminal side in FIGS. 2 to 11, which will not be repeated in the present disclosure.

The present disclosure will describe the above-mentioned various embodiments in combination with practical applications hereinafter.

In an implementation, a first device determines the number of reception beams supported by a beam prediction model, and the first device is a terminal or a network device.

In some embodiments, the first device receives indication information from a second device, and the indication information is used to indicate the number of reception beams supported by the beam prediction model. If the first device is the terminal, the second device is the network device. If the first device is the network device, the second device is the terminal.

In some embodiments, the first device trains the beam prediction model, so the first device can directly determine the number of reception beams supported by the beam prediction model.

In an implementation, the number of reception beams supported by the beam prediction model includes: a maximum number Rx_num of reception beams, or all numbers of reception beams that can be supported.

In some embodiments, all the numbers of reception beams that can be supported may be: Rx_num, Rx_num/2, Rx_num/4, Rx_num/8, . . . , 1.

In an implementation, the first device determines N optimal beam pairs from the output of the beam prediction model, and the determination method may be indicated by the second device or a default method.

In an implementation, if the output of the beam prediction model is RSRPs of all beam pairs (the number of all beam pairs is the product of the number Tx_num of transmission beams of the network device and a maximum number Rx_num of reception beams supported by the model).

If the number of reception beams of the terminal is Rx_num, N beam pairs with the strongest RSRP are directly determined from all beam pairs.

If the number of reception beams of the terminal is Rx_num/2, the N beam pairs with the strongest RSRP are determined from half of all the beam pairs.

If the number of reception beams of the terminal is Rx_num/4, the N beam pairs with the strongest RSRP are determined from ¼ of all the beam pairs.

In some embodiments, if the number of reception beams of the terminal is Rx_num/2, the half of the beam pairs may be:
the first half, or the second half (i.e., beam pair IDs in each group are continuous); or
the half with odd numbers, or the half with even numbers (i.e., beam pair IDs in each group are discontinuous); or
all the beam pairs are divided into Rx_num groups, the number of beam pairs included in each group is Tx_num beam pairs (i.e., all the beam pairs in each group have the same corresponding reception beam), and the half is all beam pairs in odd or even groups. For example, if Rx_num is 8, there are 8 groups, and the half is beam pairs in groups 1, 3, 5, 7 or 2, 4, 6, 8. For example, if Tx_num of the network device is 32, each group has 32 beam pairs.

In some embodiments, if the number of reception beams of the terminal is Rx_num/4, the ¼ of the beam pairs may be:
all beam pairs are divided into 4 groups, any of the 4 groups (i.e., the beam pair IDs in each group are continuous or discontinuous); or
all the beam pairs are divided into Rx_num groups, the number of beam pairs included in each group is Tx_num beam pairs, and the ¼ of the beam pairs is all beam pairs in the Rx_num/4 groups. For example, if Rx_num is 8, there are 8 groups, and the ¼ of the beam pairs is beam pairs included in groups 1, 5, or groups 2, 6, or groups 3, 7, or groups 4, 8.

In an implementation, the output of the beam prediction model is IDs of the N optimal beam pairs among all beam pairs. The first device determines the optimal beam according to the IDs of the N optimal beam pairs.

In an implementation, if the number of reception beams supported by the beam prediction model is Rx_num, Rx_num/2, and Rx_num/4, IDs of the N optimal beam pairs output by the beam prediction model may be that all the beam pairs are divided into 4 groups, and each group outputs IDs of N/4 optimal beam pairs.

In some embodiments, all the beam pairs are divided into 4 groups, which may include:
IDs of the beam pairs included in each group are continuous;
IDs of the beam pairs included in each group are discontinuous; or
all beam pairs are divided into Rx_num groups, the number of beam pairs included in each group is Tx_num beam pairs, and the ¼ of the beam pairs is all beam pairs in the Rx_num/4 groups. For example, if Rx_num is 8, there are 8 groups, and the ¼ of the beam pairs is beam pairs included in groups 1, 5, or groups 2, 6, or groups 3, 7, or groups 4, 8.

In some embodiments, if the number of reception beams of the terminal is Rx_num, the IDs of the N optimal beam pairs are directly obtained.

In some embodiments, if the number of reception beams of the terminal is Rx_num/2, only the IDs of the N/2 optimal beam pairs output from half of the beam pairs can be obtained.

In some embodiments, half of the beam pairs may include:
the first half, or the second half (i.e., IDs of the corresponding beam pairs are continuous); or
the half with odd numbers, or the half with even numbers (i.e., IDs of the corresponding beam pairs are discontinuous); or
all the beam pairs are divided into Rx_num groups, the number of beam pairs included in each group is Tx_num beam pairs, and the half of the beam pairs are all beam pairs in odd or even groups. For example, if Rx_num is 8, there are 8 groups, and the half of the beam pairs are beam pairs in groups 1, 3, 5, 7 or 2, 4, 6, 8.

In some embodiments, if the number of reception beams of the terminal is Rx_num/4, only the IDs of the N/4 optimal beam pairs output from ¼ of the beam pairs can be obtained.

In some embodiments, ¼ of the beam pairs may include:
all beam pairs are divided into 4 groups, any of the 4 groups (i.e., the beam pair IDs in each group are continuous or discontinuous); or
all beam pairs are divided into Rx_num groups, the number of beam pairs included in each group is Tx_num beam pairs, and the ¼ of the beam pairs is all beam pairs in the Rx_num/4 groups. For example, if Rx_num is 8, there are 8 groups, and the ¼ of the beam pairs is beam pairs included in groups 1, 5, or groups 2, 6, or groups 3, 7, or groups 4, 8.

In the present disclosure, the optimal beam can be determined from the output of the beam prediction model through the number of reception beams supported by the beam prediction model, so that terminals supporting different numbers of reception beams can use the same beam prediction model to determine the optimal beam suitable for each terminal.

It should be noted that those skilled in the art can understand that the various implementations/embodiments involved in embodiments of the present disclosure can be used in conjunction with the aforementioned embodiments or can be used independently. Whether used alone or in conjunction with the aforementioned embodiments, the implementation principle is similar. In embodiments of the present disclosure, some embodiments are described in terms of implementation methods used together. Alternatively, those skilled in the art can understand that such examples are not limitations of the embodiments of the present disclosure.

Based on the same concept, embodiments of the present disclosure further provide an apparatus and a device for determining a beam.

It can be understood that in order to implement the above-mentioned functions, the apparatus and the device for determining the beam provided in embodiments of the present disclosure include corresponding hardware structures and/or software modules for executing respective functions. In combination with units and algorithm steps of various examples disclosed in embodiments of the present disclosure, embodiments of the present disclosure may be implemented by in a form of hardware or a combination of the hardware and computer software. Whether a certain function is implemented in the fashion of hardware or in the fashion that the computer software drives the hardware depends on a particular application and design constraints of the technical solution. A person skilled in the art may implement the described functions with different methods for each particular application, but such an implementation shall not be regarded as going beyond the scope of the technical solution according to embodiments of the present disclosure.

FIG. 22 shows a schematic diagram of an apparatus for determining a beam according to an embodiment of the present disclosure. Referring to FIG. 22, the apparatus 200 is configured in a terminal, and includes: a determination module 201, configured to determine the number of reception beams supported by a beam prediction model; and the determination module 201 is further configured to determine an optimal beam from an output of the beam prediction model based on the number of reception beams supported by the beam prediction model.

In the present disclosure, the optimal beam can be determined from the output of the beam prediction model through the number of reception beams supported by the beam prediction model, so that terminals supporting different numbers of reception beams can use the same beam prediction model to determine the optimal beam suitable for each terminal.

In an embodiment, the apparatus 200 further includes: a receiving module 202, configured to receive first indication information sent by a network device, and the first indication information is used to indicate the number of reception beams supported by the beam prediction model; and the determination module 201 is further configured to determine the number of reception beams supported by the beam prediction model based on the first indication information.

In the present disclosure, the number of reception beams supported by the beam prediction model can also be determined through the indication information from another device, so as to determine the optimal beam from the output of the beam prediction model based on the number of reception beams supported by the beam prediction model, so that terminals supporting different numbers of reception beams can use the same beam prediction model to determine the optimal beam suitable for each terminal.

In an embodiment, the number of reception beams supported by the beam prediction model includes: a maximum number of reception beams supported by the beam prediction model; or, one or more numbers of reception beams supported by the beam prediction model.

In the present disclosure, the optimal beam is determined from the output of the beam prediction model through the number of reception beams that the beam prediction model can support, so that terminals supporting different numbers of reception beams can use the same beam prediction model to determine the optimal beam suitable for each terminal.

In an embodiment, in response to the beam prediction model supporting a plurality of numbers of reception beams, the plurality of numbers of reception beams include a first number and a second number; and the first number is the maximum number of reception beams supported by the beam prediction model, the first number is N times the second number, a minimum value of the second number is 1, and N is a positive integer.

In the present disclosure, the beam prediction model can support the plurality of different numbers of reception beams, so that terminals supporting different numbers of reception beams can use the same beam prediction model to determine the optimal beam suitable for each terminal.

In an embodiment, the receiving module 202 is further configured to receive second indication information sent by the network device; and the determination module 201 is further configured to determine the optimal beam from the output of the beam prediction model based on the second indication information; or, the determination module 201 is further configured to determine the optimal beam from the output of the beam prediction model according to a predefined rule.

In the present disclosure, the optimal beam can be determined from the output of the beam prediction model through the indication information of the second device or the predefined rule, so that terminals supporting different numbers of reception beams can use the same beam prediction model to determine the optimal beam suitable for each terminal.

In an embodiment, the determination module 201 is further configured to: in response to the output of the beam prediction model including beam quality information of a maximum number of beam pairs supported by the beam prediction model, determine the optimal beam from the output of the beam prediction model based on the number of reception beams supported by the terminal.

In the present disclosure, when the output of the beam prediction model includes the beam quality information of the maximum number of beam pairs supported by the beam prediction model, the optimal beam can be determined from the output of the beam prediction model based on the number of reception beams supported by the terminal, so that terminals supporting different numbers of reception beams can use the same beam prediction model to determine the optimal beam suitable for each terminal.

In an embodiment, the determination module 201 is further configured to: in response to the number of reception beams supported by the terminal being a maximum number of reception beams supported by the beam prediction model, determine the optimal beam from the maximum number of beam pairs.

In the present disclosure, when the number of reception beams supported by the terminal is the maximum number of reception beams supported by the beam prediction model, the optimal beam can be determined from the maximum number of beam pairs output by the beam prediction model, so that the beam prediction model can adapt to the terminal whose number of reception beams is the maximum number of reception beams supported by the beam prediction model.

In an embodiment, the determination module 201 is further configured to: in response to the number of reception beams supported by the terminal being a third number, divide the maximum number of beam pairs into M groups, and determine the optimal beam from beam pairs included in any one of the M groups, wherein the third number is 1/M of a maximum number of reception beams supported by the beam prediction model, and M is a positive integer.

In the present disclosure, when the number of reception beams supported by the terminal is within the maximum number of reception beams supported by the beam prediction model, the maximum number of beam pairs is grouped, and the optimal beam is determined from a plurality of beam pairs in any group, so that the beam prediction model can adapt to the terminal whose number of reception beams is within the maximum number of reception beams supported by the beam prediction model.

In an embodiment, the determination module 201 is further configured to perform at least one of: dividing the maximum number of beam pairs into the M groups according to a beam pair, wherein numbers of beam pairs in each group are continuous or discontinuous; dividing the maximum number of beam pairs into the M groups according to a reception beam corresponding to a beam pair, wherein beam pairs corresponding to the same reception beam belong to the same group; or dividing the maximum number of beam pairs into the M groups, wherein the beam pairs corresponding to the same reception beam are divided into M sub-groups, and the M sub-groups and the M groups are in one-to-one correspondence.

The present disclosure provides a variety of different ways to group the maximum number of beam pairs, so that when the number of reception beams supported by the terminal is within the maximum number of reception beams supported by the beam prediction model, the optimal beam can be determined from the plurality of beam pairs in any group, and then the beam prediction model can adapt to the terminal whose number of reception beams is within the maximum number of reception beams supported by the beam prediction model.

In an embodiment, the determination module 201 is further configured to: in response to the output of the beam prediction model including a candidate optimal beam, determine the optimal beam according to the candidate optimal beam.

In the present disclosure, when the output of the beam prediction model includes the candidate optimal beams, the optimal beam can be determined from the candidate optimal beams based on the number of reception beams supported by the terminal, so that terminals supporting different numbers of reception beams can use the same beam prediction model to determine the optimal beam suitable for each terminal.

In an embodiment, the determination module 201 is further configured to: determine L minimum reception beam groups according to a ratio L between a maximum number of reception beams and a minimum number of reception beams supported by the beam prediction model, wherein each minimum reception beam group corresponds to a plurality of beam pairs; determine a candidate optimal beam corresponding to each minimum reception beam group output by the beam prediction model; and determine the optimal beam based on the number of reception beams supported by the terminal and the candidate optimal beam corresponding to each minimum reception beam group.

In the present disclosure, when the output of the beam prediction model includes the candidate optimal beams, the maximum number of beam pairs supported by the beam prediction model can be divided into the plurality of minimum reception beam groups according to the maximum number of reception beams and the minimum number of reception beams supported by the beam prediction model, so as to determine the optimal beam based on the number of reception beams supported by the terminal and using the candidate optimal beams corresponding to one or more minimum reception beam groups, so that terminals supporting different numbers of reception beams can use the same beam prediction model to determine the optimal beam suitable for each terminal.

In an embodiment, the minimum reception beam group corresponding to the plurality of beam pairs satisfies any one of: numbers of beam pairs in each minimum reception beam group being continuous; beam pairs corresponding to the same reception beam belonging to the same minimum reception beam group: or the beam pairs corresponding to the same reception beam being divided into L sub-groups, and the L sub-groups and the L minimum reception beam groups being in one-to-one correspondence.

The present disclosure provides a plurality of different ways of forming minimum reception beam groups, so that when the output of the beam prediction model includes the candidate optimal beams, the optimal beam can be determined based on the number of reception beams supported by the terminal and the candidate optimal beams corresponding to the minimum reception beam group. Therefore, terminals supporting different numbers of reception beams can use the same beam prediction model to determine the optimal beam suitable for each terminal.

In an embodiment, the determination module 201 is further configured to: in response to the number of reception beams supported by the terminal being K times the minimum number of reception beams, determine the optimal beam according to candidate optimal beams corresponding to K minimum reception beam groups, wherein K is a positive integer and the number of reception beams supported by the terminal is less than or equal to the maximum number of reception beams.

In the present disclosure, the optimal beam can be determined based on the different numbers of reception beams supported by the terminal combined with the candidate optimal beams corresponding to the minimum reception beam group, so that terminals supporting different numbers of reception beams can use the same beam prediction model to determine the optimal beam suitable for each terminal.

FIG. 23 shows a schematic diagram of another apparatus for determining a beam according to an embodiment of the present disclosure. Referring to FIG. 23, the apparatus 300 is configured in a network device, and includes: a determination module 301, configured to determine the number of reception beams supported by a beam prediction model; and the determination module 301 is further configured to determine an optimal beam from an output of the beam prediction model based on the number of reception beams supported by the beam prediction model.

In the present disclosure, the optimal beam can be determined from the output of the beam prediction model through the number of reception beams supported by the beam prediction model, so that terminals supporting different numbers of reception beams can use the same beam prediction model to determine the optimal beam suitable for each terminal.

In an embodiment, the apparatus 300 further includes: a receiving module 302, configured to receive first indication information sent by a terminal, and the first indication information is used to indicate the number of reception beams supported by the beam prediction model; and the determination module 301 is further configured to determine the number of reception beams supported by the beam prediction model based on the first indication information.

In the present disclosure, the number of reception beams supported by the beam prediction model can also be determined through the indication information from another device, so as to determine the optimal beam from the output of the beam prediction model based on the number of reception beams supported by the beam prediction model, so that terminals supporting different numbers of reception beams can use the same beam prediction model to determine the optimal beam suitable for each terminal.

In an embodiment, the number of reception beams supported by the beam prediction model includes: a maximum number of reception beams supported by the beam prediction model; or, one or more numbers of reception beams supported by the beam prediction model.

In the present disclosure, the optimal beam is determined from the output of the beam prediction model through the number of reception beams that the beam prediction model can support, so that terminals supporting different numbers of reception beams can use the same beam prediction model to determine the optimal beam suitable for each terminal.

In an embodiment, in response to the beam prediction model supporting a plurality of numbers of reception beams, the plurality of numbers of reception beams include a first number and a second number; and the first number is the maximum number of reception beams supported by the beam prediction model, the first number is N times the second number, a minimum value of the second number is 1, and N is a positive integer.

In the present disclosure, the beam prediction model can support the plurality of different numbers of reception beams, so that terminals supporting different numbers of reception beams can use the same beam prediction model to determine the optimal beam suitable for each terminal.

In an embodiment, the receiving module 302 is further configured to receive second indication information sent by the terminal; and the determination module 301 is further configured to determine the optimal beam from the output of the beam prediction model based on the second indication information; or, the determination module 301 is further configured to determine the optimal beam from the output of the beam prediction model according to a predefined rule.

In the present disclosure, the optimal beam can be determined from the output of the beam prediction model through the indication information of the second device or the predefined rule, so that terminals supporting different numbers of reception beams can use the same beam prediction model to determine the optimal beam suitable for each terminal.

In an embodiment, the determination module 301 is further configured to: in response to the output of the beam prediction model including beam quality information of a maximum number of beam pairs supported by the beam prediction model, determine the optimal beam from the output of the beam prediction model based on the number of reception beams supported by the terminal.

In the present disclosure, when the output of the beam prediction model includes the beam quality information of the maximum number of beam pairs supported by the beam prediction model, the optimal beam can be determined from the output of the beam prediction model based on the number of reception beams supported by the terminal, so that terminals supporting different numbers of reception beams can use the same beam prediction model to determine the optimal beam suitable for each terminal.

In an embodiment, the determination module 301 is further configured to: in response to the number of reception beams supported by the terminal being a maximum number of reception beams supported by the beam prediction model, determine the optimal beam from the maximum number of beam pairs.

In the present disclosure, when the number of reception beams supported by the terminal is the maximum number of reception beams supported by the beam prediction model, the optimal beam can be determined from the maximum number of beam pairs output by the beam prediction model, so that the beam prediction model can adapt to the terminal whose number of reception beams is the maximum number of reception beams supported by the beam prediction model.

In an embodiment, the determination module 301 is further configured to: in response to the number of reception beams supported by the terminal being a third number, divide the maximum number of beam pairs into M groups, and determine the optimal beam from beam pairs included in any one of the M groups, wherein the third number is 1/M of a maximum number of reception beams supported by the beam prediction model, and M is a positive integer.

In the present disclosure, when the number of reception beams supported by the terminal is within the maximum number of reception beams supported by the beam prediction model, the maximum number of beam pairs is grouped, and the optimal beam is determined from a plurality of beam pairs in any group, so that the beam prediction model can adapt to the terminal whose number of reception beams is within the maximum number of reception beams supported by the beam prediction model.

In an embodiment, the determination module 301 is further configured to perform at least one of: dividing the maximum number of beam pairs into the M groups according to a beam pair, wherein numbers of beam pairs in each group are continuous or discontinuous; dividing the maximum number of beam pairs into the M groups according to a reception beam corresponding to a beam pair, wherein beam pairs corresponding to the same reception beam belong to the same group; or dividing the maximum number of beam pairs into the M groups, wherein the beam pairs corresponding to the same reception beam are divided into M sub-groups, and the M sub-groups and the M groups are in one-to-one correspondence.

The present disclosure provides a variety of different ways to group the maximum number of beam pairs, so that when the number of reception beams supported by the terminal is within the maximum number of reception beams supported by the beam prediction model, the optimal beam can be determined from the plurality of beam pairs in any group, and then the beam prediction model can adapt to the terminal whose number of reception beams is within the maximum number of reception beams supported by the beam prediction model.

In an embodiment, the determination module 301 is further configured to: in response to the output of the beam prediction model including a candidate optimal beam, determine the optimal beam according to the candidate optimal beam.

In the present disclosure, when the output of the beam prediction model includes the candidate optimal beams, the optimal beam can be determined from the candidate optimal beams based on the number of reception beams supported by the terminal, so that terminals supporting different numbers of reception beams can use the same beam prediction model to determine the optimal beam suitable for each terminal.

In an embodiment, the determination module 301 is further configured to: determine L minimum reception beam groups according to a ratio L between a maximum number of reception beams and a minimum number of reception beams supported by the beam prediction model, wherein each minimum reception beam group corresponds to a plurality of beam pairs; determine a candidate optimal beam corresponding to each minimum reception beam group output by the beam prediction model; and determine the optimal beam based on the number of reception beams supported by the terminal and the candidate optimal beam corresponding to each minimum reception beam group.

In the present disclosure, when the output of the beam prediction model includes the candidate optimal beams, the maximum number of beam pairs supported by the beam prediction model can be divided into the plurality of minimum reception beam groups according to the maximum number of reception beams and the minimum number of reception beams supported by the beam prediction model, so as to determine the optimal beam based on the number of reception beams supported by the terminal and using the candidate optimal beams corresponding to one or more minimum reception beam groups, so that terminals supporting different numbers of reception beams can use the same beam prediction model to determine the optimal beam suitable for each terminal.

In an embodiment, the minimum reception beam group corresponding to the plurality of beam pairs satisfies any one of: numbers of beam pairs in each minimum reception beam group being continuous; beam pairs corresponding to the same reception beam belonging to the same minimum reception beam group; or the beam pairs corresponding to the same reception beam being divided into L sub-groups, and the L sub-groups and the L minimum reception beam groups being in one-to-one correspondence.

The present disclosure provides a plurality of different ways of forming minimum reception beam groups, so that when the output of the beam prediction model includes the candidate optimal beams, the optimal beam can be determined based on the number of reception beams supported by the terminal and the candidate optimal beams corresponding to the minimum reception beam group. Therefore, terminals supporting different numbers of reception beams can use the same beam prediction model to determine the optimal beam suitable for each terminal.

In an embodiment, the determination module 301 is further configured to: in response to the number of reception beams supported by the terminal being K times the minimum number of reception beams, determine the optimal beam according to candidate optimal beams corresponding to K minimum reception beam groups, wherein K is a positive integer and the number of reception beams supported by the terminal is less than or equal to the maximum number of reception beams.

In the present disclosure, the optimal beam can be determined based on the different numbers of reception beams supported by the terminal combined with the candidate optimal beams corresponding to the minimum reception beam group, so that terminals supporting different numbers of reception beams can use the same beam prediction model to determine the optimal beam suitable for each terminal.

Regarding the apparatus 200 and the apparatus 300 in the above embodiments, the specific manner in which each module performs operations has been described in detail in the method embodiments, which will not be elaborated here.

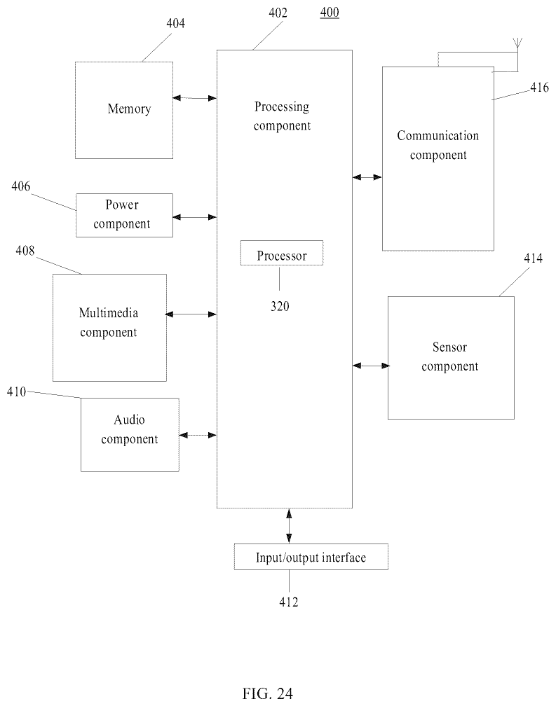

FIG. 24 shows a schematic diagram of a device for determining a beam according to an embodiment of the present disclosure. For example, the device 400 may be any terminal such as a mobile phone, a computer, a digital broadcast terminal, a messaging device, a gaming console, a tablet device, a medical device, an exercise device, a personal digital assistant, etc.

Referring to FIG. 24, the device 400 may include one or more of the following components: a processing component 402, a memory 404, a power component 406, a multimedia component 408, an audio component 410, an input/output (I/O) interface 412, a sensor component 414, and a communication component 416.

The processing component 402 typically controls overall operations of the device 400, such as the operations associated with display, telephone calls, data communications, camera operations, and recording operations. The processing component 402 may include one or more processors 320 to execute instructions to complete all or part of the steps in the above described methods. Moreover, the processing component 402 may include one or more modules which facilitate the interaction between the processing component 402 and other components. For example, the processing component 402 may include a multimedia module to facilitate the interaction between the multimedia component 408 and the processing component 402.

The memory 404 is configured to store various types of data to support the operation of the device 400. Examples of such data include instructions for any applications or methods operated on the device 400, contact data, phonebook data, messages, pictures, video, etc. The memory 404 may be implemented using any type of volatile or non-volatile memory apparatuses, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 406 provides power to various components of the device 400. The power component 406 may include a power management system, one or more power sources, and any other components associated with the generation, management, and distribution of power in the device 400.

The multimedia component 408 includes a screen providing an output interface between the device 400 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a duration and a pressure associated with the touch or swipe action. In some embodiments, the multimedia component 408 includes a front camera and/or a rear camera. The front camera and the rear camera may receive an external multimedia datum while the device 400 is in an operation mode, such as a photographing mode or a video mode. Each of the front camera and the rear camera may be a fixed optical lens system or have focus and optical zoom capability.

The audio component 410 is configured to output and/or input audio signals. For example, the audio component 410 includes a microphone (MIC) configured to receive an external audio signal when the device 400 is in an operation mode, such as a call mode, a recording mode, and a voice recognition mode. The received audio signal may be further stored in the memory 404 or transmitted via the communication component 416. In some embodiments, the audio component 410 further includes a speaker to output audio signals.

The I/O interface 412 provides an interface between the processing component 402 and peripheral interface modules, such as a keyboard, a click wheel, buttons, and the like. The buttons may include, but are not limited to, a home button, a volume button, a starting button, and a locking button.

The sensor component 414 includes one or more sensors to provide state assessments of various aspects of the device 400. For example, the sensor component 414 may detect an open/closed state of the device 400, relative positioning of components, e.g., the display and the keypad, of the device 400, a change in position of the device 400 or a component of the device 400, a presence or absence of user contact with the device 400, an orientation or an acceleration/deceleration of the device 400, and a change in temperature of the device 400. The sensor component 414 may include a proximity sensor configured to detect the presence of nearby objects without any physical contact. The sensor component 414 may also include a light sensor, such as a CMOS or CCD image sensor, for use in imaging applications. In some embodiments, the sensor component 414 may also include an accelerometer sensor, a gyroscope sensor, a magnetic sensor, a pressure sensor, or a temperature sensor.

The communication component 416 is configured to facilitate communication, wired or wirelessly, between the device 400 and other devices. The device 400 may access a wireless network based on a communication standard, such as Wi-Fi, 2G or 3G, or a combination thereof. In an embodiment, the communication component 416 receives a broadcast signal or broadcast associated information from an external broadcast management system via a broadcast channel. In an embodiment, the communication component 416 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an embodiment of the present disclosure, the device 400 may be implemented with one or more application specific integrated circuits (ASICs), digital signal processors (DSPs), digital signal processing devices (DSPDs), programmable logic devices (PLDs), field programmable gate arrays (FPGAs), controller, micro-controller, microprocessors, or other electronic components, for performing the above described methods.

In an embodiment of the present disclosure, there is further provided a non-transitory computer readable storage medium including instructions, such as the memory 404 including instructions, the above instructions may be executed by the processor 320 in the device 400 for completing the above-described methods. For example, the non-transitory computer-readable storage medium may be a ROM, a Random Access Memory (RAM), a CD-ROM, a magnetic tape, a floppy disc, an optical data storage device, and the like.

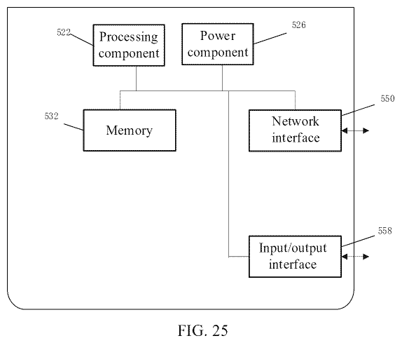

FIG. 25 shows a schematic diagram of another device for determining a beam according to an embodiment of the present disclosure. For example, the device 500 may be provided as a base station or a server. Referring to FIG. 25, the device 500 includes a processing component 522, which further includes one or more processors and a memory resource represented by a memory 532 for storing instructions executable by the processing component 522, such as an application program. The application program stored in the memory 532 may include one or more modules, each corresponding to a set of instructions. In addition, the processing component 522 is configured to execute the instructions to execute the aforementioned method.

The device 500 may further include: a power component 526 configured to perform power management of the device 500, a wired or wireless network interface 550 configured to connect the device 500 to the network, and an input/output (I/O) interface 558. The device 500 may operate an operating system stored in the memory 532, such as Windows Server™, Mac OS X™, Unix™, Linux™, FreeBSD™, or the like.

In the present disclosure, the optimal beam can be determined from the output of the beam prediction model through the number of reception beams supported by the beam prediction model, so that terminals supporting different numbers of reception beams can use the same beam prediction model to determine the optimal beam suitable for each terminal.

In the present disclosure, the same beam measurement model can be used for terminals supporting different numbers of reception beams to obtain optimal beam pair information, thereby improving the generalization of the beam measurement model, so that the same beam measurement model can be applied to terminals with different numbers of reception beams.

It can be further understood that in the present disclosure, “a plurality” refers to two or more, and other quantifiers are analogous to it. “and/or” is used to describe an associated relationship between associated objects and means three relationships, for instance, A and/or B may mean A alone, A and B together, and B alone. The character “/” generally indicates that the associated objects are in an “or” relationship. Singular forms “a”, “an” and “the” are intended to include plural forms as well, unless the context clearly indicates otherwise.

It can be further understood that the terms “first”, “second”, etc. are used to describe various information, but the information should not be limited by these terms. These terms are merely used to distinguish the same type of information from each other and do not denote a particular order or degree of importance. Indeed, the expressions “first”, “second”, etc. may be used interchangeably. For instance, first information may also be referred to as second information, and similarly, second information may also be referred to as first information, without departing from the scope of the present disclosure.

It can be further understood the meanings of the words “in response to” and “if” involved in the present disclosure depend on the context and the actual usage scenario. For example, the word “in response to” as used herein can be interpreted as “upon” or “when” or “if” or “in case”.

It can be further understood that although the operations in embodiments of the present disclosure are described in a specific order in the drawings, they should not be understood as requiring that the operations are performed in the specific order shown or in a serial order, or that all the operations shown are performed to get the desired result. In certain environments, multitasking and parallel processing may be advantageous.

Other implementations of the present disclosure will be apparent to those skilled in the art from consideration of the specification and practice of the present disclosure disclosed here. The present disclosure is intended to cover any variations, uses, or adaptations of the present disclosure following the general principles thereof and including the common general knowledge or habitual technical means in the technical field not disclosed in the present disclosure.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

1. A method for determining a beam, performed by a first device, and comprising:
determining a number of reception beams supported by a beam prediction model; and
determining an optimal beam from an output of the beam prediction model based on the number of reception beams supported by the beam prediction model.

2. The method according to claim 1, wherein determining the number of reception beams supported by the beam prediction model comprises:
receiving first indication information sent by a second device, wherein the first indication information is configured to indicate the number of reception beams supported by the beam prediction model; and
determining, based on the first indication information, information on the number of reception beams supported by the beam prediction model.

3. The method according to claim 1, wherein the number of reception beams supported by the beam prediction model comprises:
a maximum number of reception beams supported by the beam prediction model; or,
one or more numbers of reception beams supported by the beam prediction model.

4. The method according to claim 3, wherein in response to the beam prediction model supporting a plurality of numbers of reception beams, the plurality of numbers of reception beams comprise a first number and a second number; and
the first number is the maximum number of reception beams supported by the beam prediction model, the first number is N times the second number, a minimum value of the second number is 1, and N is a positive integer.

5. The method according to claim 1, wherein determining the optimal beam from the output of the beam prediction model comprises:
receiving second indication information sent by a second device, and determining the optimal beam from the output of the beam prediction model based on the second indication information; or,
determining the optimal beam from the output of the beam prediction model according to a predefined rule.

6. The method according to claim 5, wherein determining the optimal beam from the output of the beam prediction model comprises:
in response to the output of the beam prediction model comprising beam quality information of a maximum number of beam pairs supported by the beam prediction model, determining the optimal beam from the output of the beam prediction model based on a number of reception beams supported by the terminal.

7. The method according to claim 6, wherein determining the optimal beam from the output of the beam prediction model based on the number of reception beams supported by the terminal comprises:
in response to the number of reception beams supported by the terminal being a maximum number of reception beams supported by the beam prediction model, determining the optimal beam from the maximum number of beam pairs.

8. The method according to claim 6, wherein determining the optimal beam from the output of the beam prediction model based on the number of reception beams supported by the terminal comprises:
in response to the number of reception beams supported by the terminal being a third number, dividing the maximum number of beam pairs into M groups, and determining the optimal beam from beam pairs comprised in any one of the M groups, wherein the third number is 1/M of a maximum number of reception beams supported by the beam prediction model, and M is a positive integer.

9. The method according to claim 8, wherein dividing the maximum number of beam pairs into the M groups comprises at least one of:
dividing the maximum number of beam pairs into the M groups according to a beam pair, wherein numbers of beam pairs in each group are continuous or discontinuous;
dividing the maximum number of beam pairs into the M groups according to a reception beam corresponding to a beam pair, wherein beam pairs corresponding to the same reception beam belong to the same group; or
dividing the maximum number of beam pairs into the M groups, wherein the beam pairs corresponding to the same reception beam are divided into M sub-groups, and the M sub-groups and the M groups are in one-to-one correspondence.

10. The method according to claim 5, wherein determining the optimal beam from the output of the beam prediction model comprises:
in response to the output of the beam prediction model comprising a candidate optimal beam, determining the optimal beam according to the candidate optimal beam.

11. The method according to claim 10, wherein determining the optimal beam according to the candidate optimal beam comprises:
determining L minimum reception beam groups according to a ratio L between a maximum number of reception beams and a minimum number of reception beams supported by the beam prediction model, wherein each minimum reception beam group corresponds to a plurality of beam pairs;
determining a candidate optimal beam corresponding to each minimum reception beam group output by the beam prediction model; and
determining the optimal beam based on a number of reception beams supported by the terminal and the candidate optimal beam corresponding to each minimum reception beam group.

12. The method according to claim 11, wherein the minimum reception beam group corresponding to the plurality of beam pairs satisfies any one of:
numbers of beam pairs in each minimum reception beam group being continuous;
beam pairs corresponding to the same reception beam belonging to the same minimum reception beam group; or
the beam pairs corresponding to the same reception beam being divided into L sub-groups, and the L sub-groups and the L minimum reception beam groups being in one-to-one correspondence.

13. The method according to claim 11, wherein determining the optimal beam based on the number of reception beams supported by the terminal and the candidate optimal beam corresponding to each minimum reception beam group comprises:
in response to the number of reception beams supported by the terminal being K times the minimum number of reception beams, determining the optimal beam according to candidate optimal beams corresponding to K minimum reception beam groups, wherein K is a positive integer and the number of reception beams supported by the terminal is less than or equal to the maximum number of reception beams.

14. The method according to claim 1, wherein the first device is a terminal and the second device is a network device; or
the first device is the network device and the second device is the terminal.

15. (canceled)

16. (canceled)

17. A device for determining a beam, comprising:
a processor; and
a memory configured to store executable instructions of the processor;
wherein the processor is configured to:
determine a number of reception beams supported by a beam prediction model;
determine an optimal beam from an output of the beam prediction model based on the number of reception beams supported by the beam prediction model.

18. A non-transitory computer-readable storage medium storing instructions that, when executed by a processor of a first device, causes the first device to perform;
determining a number of reception beams supported by a beam prediction model; and
determining an optimal beam from an output of the beam prediction model based on the number of reception beams supported by the beam prediction model.

19. The device according to claim 17, wherein the processor is further configured to:
receive first indication information sent by a second device, wherein the first indication information is configured to indicate the number of reception beams supported by the beam prediction model; and
determine, based on the first indication information, information on the number of reception beams supported by the beam prediction model.

20. The device according to claim 17, wherein the number of reception beams supported by the beam prediction model comprises:
a maximum number of reception beams supported by the beam prediction model; or,
one or more numbers of reception beams supported by the beam prediction model.

21. The device according to claim 20, wherein in response to the beam prediction model supporting a plurality of numbers of reception beams, the plurality of numbers of reception beams comprise a first number and a second number; and
the first number is the maximum number of reception beams supported by the beam prediction model, the first number is N times the second number, a minimum value of the second number is 1, and N is a positive integer.
